(19) United States
(12) Patent Application Publication
(10) Pub. No.: US 2001/0047282 A1
(43) Pub. Date: Nov. 29, 2001

(54) System and method for managing real estate transactions

(76) Inventor: William M. Raveis JR., Fairfield, CT (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 09/759,435

(22) Filed: Jan. 11, 2001

Related U.S. Application Data
(63) Continuation-in-part of application No. 09/459,234, filed on Dec. 10, 1999.
(60) Provisional application No. 60/175,606, filed on Jan. 11, 2000.

(51) Int. Cl. G06F 17/60; G06F 7/00; G06F 17/30

(52) U.S. Cl. 705/7; 705/11; 707/9; 707/1; 705/9; 705/14

(57) ABSTRACT

Managing real estate transactions over a distributed computer network including the steps of storing data relating to a plurality of listings in a computerized database, each listing owned by an office, each office having a plurality of agents associated therewith, each office having a predefined region and at least one manager associated therewith, monitoring postings of transactions relating to the plurality of listings, and calculating commissions for the agents, the offices and the at least one manager associated with a transaction in accordance with a set of parameters.

### CROSS REFERENCE TO RELATED APPLICATIONS

This application is a continuation-in-part of U.S. patent application Ser. No. 09/459,234, filed Dec. 10, 1999, and claims priority to U.S. Provisional Patent Application Serial No. 60/175,606, filed Jan. 11, 2000, both of which are incorporated herein by reference in their entireties, respectively.

### BACKGROUND OF THE INVENTION 1. Field of the Invention

The subject invention relates to managing real estate transactions, and more particularly, to a system and method for gathering, utilizing, disseminating and controlling information relating to real estate transactions.

2. Background of the Related Art

The traditional business model for real estate companies has been to list and sell properties with a sales force of independent contractors, e.g., real estate agents. Real estate agents generally have been the main interface for customers. Real estate companies have exclusively provided real estate agents, tours of properties on the market, submission of bids and information about schools and neighborhoods. Organizations such as Multiple Listing Services (hereinafter “MLS”) developed to aid the flow of information to customers. A MLS normally prepares books, which serve as references for real estate agents. The MLS books contain photos and descriptions of property for sale (e.g., “listings”). Unfortunately, the MLS publications become outdated and are often difficult and costly to distribute.

Typically, real estate companies and sales agents rely solely on commissions generated from listing sales. It is common for a single commission to be shared by several agents and real estate companies. Current systems and methods often inappropriately distribute the commissions because of accounting error. Further, the ancillary value available by controlling the customer information and cross-selling related goods and services is missed. This missed opportunity is particularly lucrative because of the large amount of goods and services often purchased by recent home purchasers. Moreover, the higher level of service offered to customers increases the likelihood of repeat business which results in lower earnings as well.

Despite their success, current business models for real estate companies have several shortcomings. Often, referrals are lost and appointments missed, because information has not been properly recorded. Large investments in training and technology are necessary to enable sales agents to control the flow of information. Despite such large investments, no guarantee exists that the information will be managed better or value will be added for the customer. Further, such efforts can fail due to a lack of support from sales agents due to difficulty in using the technology. Thus, the need exists for a method of managing real estate transactions which is highly endorsed and supported by sales agents.

Furthermore, such investments in technology are cost prohibitive for smaller organizations. Under these circumstances, a further need exists for a proven business model, which is accompanied by turnkey software that is easy to implement and use, and yet affordably priced so that small size organizations can take advantage thereof. Moreover, the software would advantageously feature interoperability which allows the software to be enhanced by additional modules and integrated with current systems.

The proliferation of the Internet has presented an additional challenge to the traditional business model for selling real estate. The low overhead distribution of information via the Internet has created alternatives to the traditional real estate company. Customers are increasingly acquiring traditional real estate company services via the Internet without engaging a real estate agent or company. As a result, the Internet has caused a downward pressure on broker commissions and increased competition for customers. Therefore, real estate companies require an improved system and method which adds value for their customers and allows customers full access to information.

Several attempts have been made to try and improve upon systems for managing information and, in particular, information relating to a real estate company. For example, U.S. Pat. No. 5,664,115 to Fraser discloses a system for matching buyers and sellers of real estate. The system of Fraser stores a set of records corresponding to property listings. A potential buyer can access the system, via the Internet, and search the property listings according to sorting criteria. The system provides the records which meet the sorting criteria to the buyer. Further, the seller may input criteria, such as cash on hand, to narrow the prospective buyers which their listing may be shown. If the transaction is ultimately consummated, the buyer and seller may pay a fee to the system operator.

U.S. Pat. No. 5,584,025 to Keithley et al. discloses a system for processing demographic information. The system tracks when, where and how an advertisement was viewed and compiles related statistics. In a real estate related application, the system would provide agents and clients information about each other, listings and communities. Clients can contact responsible parties via telephone. A Transaction Processing Database tracks appointments and significant dates. The Agent Market Data Database is a compilation of inventory and sales reports. The Real Estate Related Services Database and the Home Services Database are compilations of vendors of real estate related services. As a result of the traffic to the system, demographic information is generated which allows targeted marketing to potential customers early in their decision process.

Further, U.S. Pat. No. 5,309,355 to Lockwood discloses an apparatus for composing individualized sales presentations from customer profiles. The sales presentations are multi-media presentations composed from a database of presentation segments arranged in categories. U.S. Pat. No. 5,680,305 to Apgar, IV discloses a system which provides business real estate reports. The reports present data related to a real estate portfolio held by a business in order to allow the business to assess the efficiency with which money is spent on real estate. The reports are calculated from a database which contains information relating to the real estate holdings of the company.

In view of the above deficient systems and methods for managing real estate companies, there is a need in the art for an improved system and method for managing a real estate company which enhances productivity by gathering, processing and controlling information in a more efficient and profitable manner.

### SUMMARY OF THE INVENTION

The subject invention is directed to system and method for managing real estate transactions over a distributed computer network. The method includes the steps of storing data relating to a plurality of listings in a computerized database. Each listing is owned by an office and each office has a plurality of agents associated therewith. In addition, each office has a predefined region and a manager associated therewith. The method further includes the steps of monitoring postings of transactions relating to the plurality of listings, and calculating commissions for the agents, the offices and the manager associated with a transaction in accordance with a set of parameters.

Another aspect of the subject method includes the step of storing data relating to advertising in the computerized database and calculating commissions for the offices based upon the data relating to the advertising. Still another aspect of the subject method includes the step of maintaining data relating to the predefined regions used to set an agent's commission split levels, whereby the agent's commission split levels determine an agent split percentage based on agent earnings. Yet another aspect of the subject method includes the steps of tracking trustee money related to the transactions and a record associated with each trustee associated with the trustee money.

The system includes means for storing data relating to a plurality of listings in a computerized database. Each listing is owned by an office and each office has a plurality of agents associated therewith. In addition, each office has a predefined region and a manager associated therewith. The method further includes means for monitoring postings of transactions relating to the plurality of listings and means for calculating commissions for the agents, the offices and the manager associated with a transaction in accordance with a set of parameters.

Another aspect of the subject system includes means for storing data relating to contacts in a computerized database where the contacts have agents and listings associated therewith. Still another aspect of the subject system includes means for storing attorneys in a database. Yet another aspect of the subject system includes means for maintaining data relating to relocation clients. The relocation clients are external companies that an office partners with. Further, means is included to allow searching among the stored relocated clients.

These and other unique features of the system and method disclosed herein will become more readily apparent from the following description and the accompanying drawings.

### BRIEF DESCRIPTION OF THE DRAWINGS

So that those having ordinary skill in the art to which the disclosed system and method appertains will more readily understand how to make and use the same, reference may be had to the drawings wherein:

FIG. 1 is an overview of an environment in which an embodiment of the present invention may be used;

FIG. 2 is a diagrammatic representation of a multi-tiered embodiment of the subject invention;

FIGS. 3A-3D are exemplary tables for defining roles and having securable entities in accordance with a preferred embodiment of the subject invention;

FIGS. 4A-4F depict a database constructed in accordance with a preferred embodiment of the subject invention;

FIG. 5 is an example of a World Wide Web page relating to a property in accordance with an embodiment of the present disclosure;

FIG. 6 is an example of a World Wide Web page relating to a contact in accordance with an embodiment of the present disclosure; and

FIG. 7 is a flowchart depicting a process for managing real estate transactions in accordance with an embodiment of the present invention.

### DETAILED DESCRIPTION OF THE PREFERRED EMBODIMENT

The present invention provides a system and method for managing real estate transactions. The system and method allows sales, management and administrative personnel of a real estate company to gather, process and control data relating to real estate transactions in an efficient cost effective manner. Additionally, the system and method provides buyers and sellers of real estate with convenient access to information relating to the real estate transactions in which they are involved.

In accordance with a preferred embodiment of the system, each of a plurality of different users perform different functions within the system. For example, the real estate company, sales agent, buyer and seller access information relating to real estate transactions stored in a database. In particular, administrative personnel of the real estate company maintain schedules and enter data while management personnel generate reports and evaluate overall performance. Sales agents can monitor activity related to a listing and a contact. Buyers and sellers of real estate can access data related to listings as well. Further, small real estate companies can access the present invention on a rental basis.

It is envisioned that the preferred embodiment will exhibit flexibility, maintainability and performance. Flexibility is critical to adapt to changing business rules and to ensure that these rules can be exposed to multiple systems. Preferably, a Component Object Model (“COM”) interface is used for business rules and data access to ensure that the COM interface can be accessed by various applications including without limitation a Listing System, and Intranet applications. Maintainability allows individuals other than the original development team to easily perform enhancements to the system. Maintainability also encompasses ease of installation and deployment. In one embodiment, a browser based solution allows updates to be easily distributed to all users via any type of network connection. Since performance bottlenecks will mostly be centered on network bandwidth, particularly at remote offices, the system preferably minimizes traffic. In another embodiment, local ActiveX controls embedded in the web interface reduces the traffic sent over the applicable network to mostly data instead of Web pages. Additionally, local ActiveX controls are a very robust interface for most user actions.

I. Overview

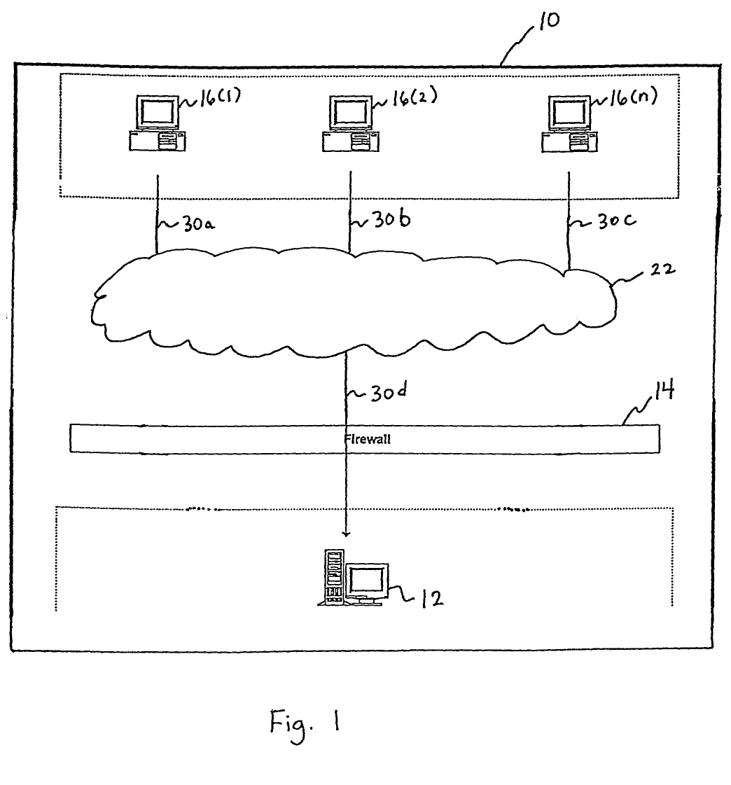

Referring to FIG. 1, there is illustrated a schematic representation of an environment 10 in which the system and method of the present invention may be implemented. The environment 10 includes server 12, which communicates with a distributed computer network 22 via communication channel 30d. Preferably, distributed computer network 22 includes a client tier. Server 12 hosts multiple web sites and house multiple databases, which can be characterized as a web tier, business tier and data tier.

Firewall 14 protects server 12 from unauthorized use. Firewalls are essential to secure Internet connectivity. Firewalls provide a critical control point for allowing authorized traffic in and keeping unauthorized traffic out. Thus, potential intruders cannot attack the systems of the subject disclosure. As an additional security measure, encryption creates further obstacles to unauthorized access and use.

It is envisioned that the preferred environment 10 may incorporate one server or multiple servers to achieve the desired performance necessary from server 12. Multiple servers can cooperate to facilitate greater performance and stability of the subject invention by distributing memory and processing. U.S. Pat. No. 5,953,012 to Venghte et al. describes a method and system for connecting to, browsing and accessing computer network resources and is herein incorporated by reference in its entirety. Similarly, U.S. Pat. No. 5,708,780 to Levergood et al. describes an Internet server which controls and monitors access to network servers and is also herein incorporated by reference in its entirety.

Distributed computer network 22 may include any number of network systems. For example, distributed computer network 22 may be a combination of local area networks (LAN), wide area networks (WAN), intranets or the Internet, as is well known. In the preferred embodiment, the computer network 22 is the Internet. The preferred method of accessing information on the Internet is the World Wide Web, because navigation is intuitive and does not require technical knowledge.

Computers 16(l)-16(n) are associated with users. When used herein, the variable “n” is in no way intended to limit the real or potential number represented. Users of the subject invention include contacts, sales agents and personnel associated with a real estate company. Contacts are home sellers and buyers. The real estate company engages sales agents who manage the contacts. Personnel associated with the real estate company may be any combination of a technical system analyst, a move consultant, a sales manager, accounting personnel and the like, who work directly or indirectly for a real estate company.

It is envisioned that many variations may provide the performance, reliability and consistency necessary for the system and method of the subject disclosure. In one embodiment, an exemplary computer 16(l)-16(n) includes a Pentium microprocessor above 120 MHz with 64 MB RAM, a 56K modem, a video monitor with at lease 800×600 pixels and 16 bit color. Further, example computer 16(l)-16(n) is running Windows 95 and Microsoft Internet Explorer 4.0 or higher.

A plurality of users may share the same computer. The plurality of users can utilize the system 10 simultaneously from the same location or a variety of locations. The computers 16(l)-16(n) allow users to access information on the server 12. The computers 16(l)-16(n) communicate with the distributed computing network 22 via communication channels 30a-30c, respectively. The communication channels 30a-30d, whether wired or wireless, are well known and therefore not further described herein. It is also envisioned that users can communicate with server 12 by a direct connection thereby alleviating the need for authentication. For example, the direct communication can be with a Local Area Network (“LAN”), by Point-to-Point Tunneling Protocol (“PPTP”) or a Remote Access Server (“RAS”).

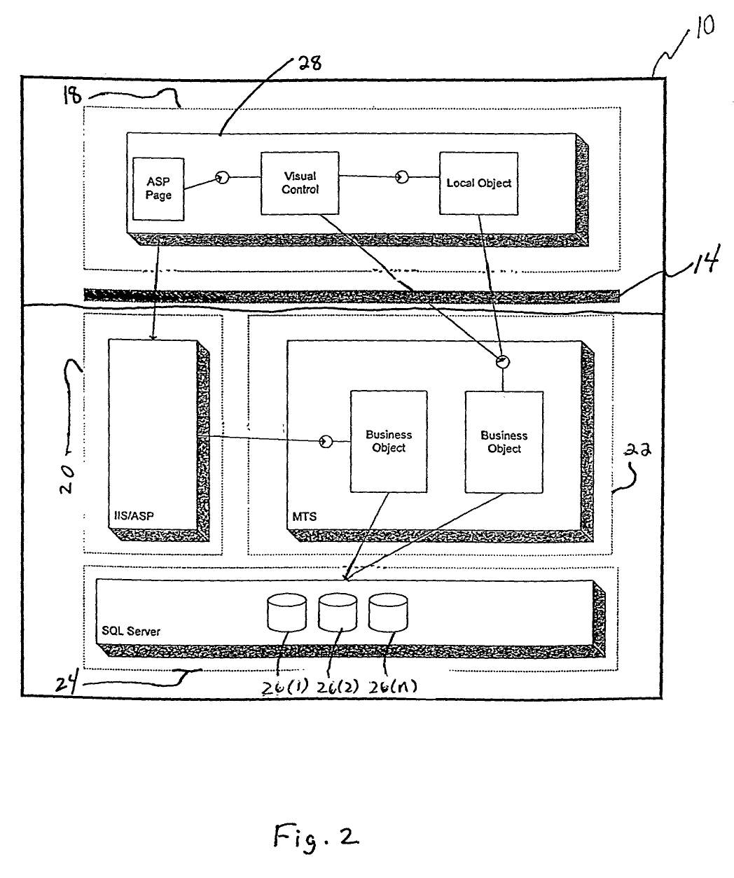

Referring now to FIG. 2, there is illustrated a diagrammatic representation of preferred embodiment 10 in accordance with the present disclosure. Data tier 24 runs a Structured Query Language (“SQL”) server and houses databases 26(l)-(n). Business tier 22 performs the core logic functions, such as retrieving requested data, applying business rules and performing updates on behalf of users in accordance with the present disclosure. Preferably, the infrastructure of business tier 22 serves as a container for ActiveX Server Components. Thus, when written as ActiveX Server Components, a component written for a single user, can be scaled to apply for many users and can be called from Active Server Pages (“ASP”).

In the preferred embodiment, web tier 20 manages HyperText Transport Protocol (“HTTP”) requests from user tier 18. Web tier 20 also returns the appropriate ASP pages utilizing MICROSOFT INTERNET INFORMATION SERVER® (“IIS”), (available from Microsoft Corporation, One Microsoft Way, Redmond, Wash. 98052-6399). User tier 18 contains browser 28, preferably Microsoft's Internet Explorer (“IE”) and additional ActiveX controls and objects. As a result, browser 28 presents a visual interface to users. In a preferred embodiment, the visual interface is delivered in the form of an ASP page containing simple text and embedded ActiveX control corresponding to an intended function. Thus, ActiveX control establishes references to local objects as well as business objects on business tier 22. In another preferred embodiment, system 10 is a hybrid intranet application wherein a portion of data is communicated via HTTP and ASP page presentation, while another portion of data is communicated via a distributed object mechanism.

II. Open Connectivity and External System Integration

Open connectivity of system 10 allows integration with an accounting software program to properly pay real estate agents, the real estate company and external commissions via a payroll module. Preferably, the accounting software program is Great Plains Dynamics C/C+ for SQL Server, (available from Great Plains Software, Inc., P.O. Box 9739, Fargo, N.D. 58109-9739).

In a preferred embodiment, the system of the subject application can be integrated with commercially available software packages and custom designed modules. For example, integration with the Great Plains Accounting module is accomplished via an integration toolkit provided by Great Plains Accounting. This toolkit is compatible with Microsoft's Component Object Model (COM). Alternatively, the proprietor may contract with a third party integrator to assist in identifying the necessary interfaces for successful integration. Various MLS data systems can provide tables that contain the necessary MLS information to be displayed in the Listing System. The MLS data will be updated on a daily basis for processing in the Listing System. Further, SMART MAILER®, available from Pitney Bowes Inc., is compatible with Microsoft Office 97. The Listing System will provide access to Listing System data via a Microsoft Access 97 database with appropriate links and queries. All mailing, sorting and addressing will be accomplished by SMARTMAILER®.

Still further, it is envisioned that standard development software tools will be utilized in connection with the subject system and method. For example, Visual Studio version 6.0 or Visual Basic can be used for development of ActiveX components within the application. Visual Interdev is available for development of HTML and ASP Web pages within the application and the Package and Deployment Wizard is used for automated setup processes for the application. Seagate Crystal Reports version 7.0 is used for development of report templates within the application and Caere OmniForm version 3.0 is used for development of line art intensive forms templates within the application. Microsoft Word 97 or an equivalent thereof is used for development of some form templates such as contracts within the application.

Further examples include Adobe Acrobat version 3.0.1 and the Adobe PDF Writer version 3.0.2 for creating PDF files for the form templates. The Acrobat Forms Author Plug-In version 3.5 is used in concert with Acrobat Exchange version 3.0 to create PDF files with form fields which are then populated with data retrieved from the database. Adobe Acrobat Reader version 3.0.1 is used for viewing the final form via the application. ERwin version 3.5 is used for maintaining current entity relationship diagrams for the listing system database. The Mabry FTP/X ActiveX control is used for FTP upload and download operations within the application. The Microsoft Internet Transfer control, which is available within VB6 as a component and has the same functionality appeared to have bugs in testing. The Mabry FTP/X ActiveX control also has several events, which make the FTP process more easily managed. FTP hostname, login and password are stored in the system registry.

Still further examples include Zaks Software NT Access Groups Component for use by the Listing System Security Context object to determine what global NT groups a user is a member of. Utilizing a third party component avoids the need to write low-level security code. The Zaks Software NTAccess Groups Component is particularly useful because of its small memory footprint and because it does not require that any additional run-time libraries be installed. The Visual Components Formula One grid control is useful for the Commission calculations. An Excel spreadsheet can be created with defined names for location or where data is to be read from and written to. Multiple Excel spreadsheets allow for the complete commission calculations. The Sheridan Active Listbar Control is used for the menu items located on the left side of the web page. The menu groups and items are data driven allowing great flexibility for the customer in setting up their menu.

III. Security

Additionally, web tier 20 authenticates and sets the security context of users in order to establish the desired functionality available to the user. Preferably, the three aspects to security in the system are initial authentication, subsequent identification and determining permission levels based on identity. When a client initially accesses the system via the Web tier, they are authenticated against the NT domain. As part of this initial authentication, a token is assigned that identifies the user throughout the remainder of the session. A list of groups that the user belongs to is also constructed with the user identified by the token. The token is then required in order for a client to gain access to a business object (e.g., a function within the system). Whenever a business object is accessed, it will use the token to query the groups the user is a member of. Based upon these groups, the permission access levels for the user against the business object can be determined. The client and business objects use a security object to determine permissions as will be discussed hereinafter.

In another embodiment, clients outside of the system proper can request the use of a business object. In situations such as this, the client is not yet tokenized and the client must already be authenticated in the NT domain through some other mechanism such as logging onto the domain interactively. Therefore, the business object will request and return a token on behalf of the client.

Preferably, the system and method of the subject invention employ a roles-based mechanism for security. Each user is assigned an account based on the assumption that all users of the system are in one domain. Each account is then assigned to one or more global NT groups. Group permissions are then assigned to securable system entities. As used hereinafter, the term secure system entity(ies) refers to any item in the system that can have a required security level assigned to it. A secure system entity normally corresponds to an area of the application, for example, “Contacts” or a field within an area.

In a preferred embodiment, there are three key aspects of consideration within the security schema as follows: (i) User identification/authentication and tokenization; (ii) Determining an authenticated user's permission level for an entity via simple lookup; and (iii) The application of special business logic to determine what data a user can view, update and delete beyond that which can be ascertained from basic entity permission lookup. The schema uses NT Challenge/Response to provide authentication. A combination of NT security, custom security components, database tables, and application logic is used to tokenize a user and to determine permission levels.

During user authentication, users of the Listing System Web application are authenticated once up front by an Active Server Pages application (“ASP Application”). The ASP Application is configured to not allow anonymous access and to only accept basic authentication. Before a user is presented with any page of the subject system and method, the user is authenticated by the NT domain controller. Authentication requires that the user enter their NT account information such as domain, account, and password data.

In addition to the authentication that takes place when a user first accesses a page in the system, additional application-specific security initialization and tokenization takes place. During user initialization and tokenization, the application startup logic performs the following processing steps:

1) Creating an instance of a Listing System Security Context object which is a stateless object responsible for establishing the security context of the user and for retrieving security and agent data on the behalf of a Security Object instance. A Security Context object will only be created on the middle tier.

2) Passing the user's authenticated account, along with a password that is only known and maintained on the server side to the Security Context object. The Security Context object uses this password to ensure that the application security token as generated in the next step is only created for a legitimately authenticated user.

3) Generating by a Security Context object a unique globally unique identifier (“GUID”) that is used as a token to identify the user throughout the duration of the session.

4) Querying by the Security Context object to the NT domain controller to determine what global groups the users are a member of, i.e., what role(s) the user is playing in the system.

5) Saving the user's token and roles in internal application tables for lookup during the resolution of permission levels.

6) Returning the token to the client side of the application so that subsequently the client can pass this token to middle tier objects.

When a client or business object needs to resolve permission levels for an entity, it does so via a Security object. A Security object instance is created and populated with the permission levels that a user has for a given entity and its sub-entities. In a preferred embodiment, security permission information for the Listing system is stored in a table with the following columns: Primary-Entity; Sub-Entity Role; and Permission.

Primary-Entity identifies a first-level function in the system and typically corresponds to a business object including “SALES”, “CONTACTS”, “AGENTS”, and “LISTINGS”. Sub-Entity identifies any entity within the Primary-Entity. Typically, sub-entity refers to field such as “COMMISSIONS_SELLING_COMMISSION PERCENT”, “COMMISSIONS_LISTING_COMMISSION PERCENT”, and “COMMISSIONS”. Sub-Entities can be defined as needed and as makes sense within the Primary-Entity. All users of the system are members of one or more “roles” such as “Agents”, “SysAdmin”, and “AdminMgrs”. Each role can have its own set of security levels for an entity or sub-entity. As used here, the term role is synonymous with NT global group. The permission level the role has for the given Primary/Entity/Sub-Entity tuple varies. The higher the level, the more capabilities the role has. Each subsequent level can be thought of as having the abilities defined by the previous level, plus additional capabilities. In one embodiment, the following permission levels are defined. NONE is a permission level where a user has no access privileges. READ allows a user to view the entity data only. ADD allows a user all the privileges of READ plus the ability to add new entity items. MODIFY allows a user all the privileges of ADD plus the ability to modify entity data. DELETE allows a user all the privileges of MODIFY plus the ability to delete entity data.

It is envisioned that a first-level entity is identified for a role in a table as a Primary-Entity with an “*” as the Sub-Entity. If no such first-level entity is found for a role, it is assumed that the role has a permission level of NONE. As such, each entry in a table defining the roles can be considered as an override of some default level.

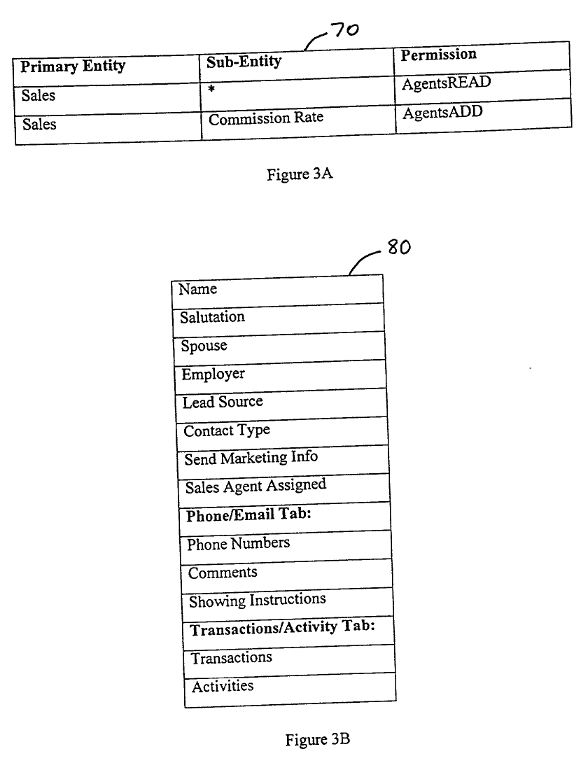

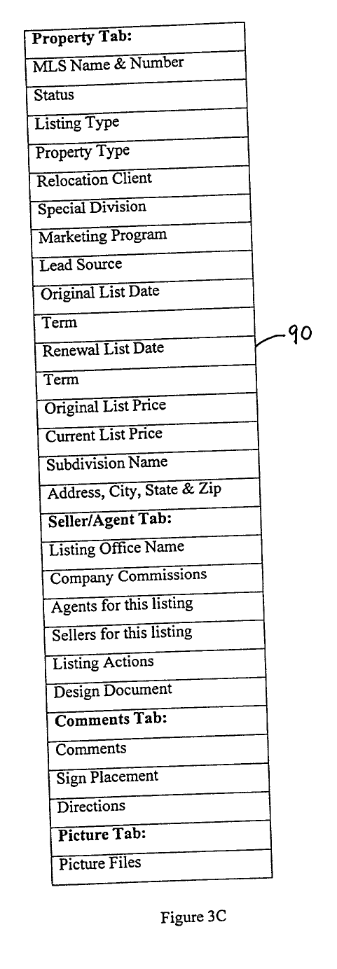

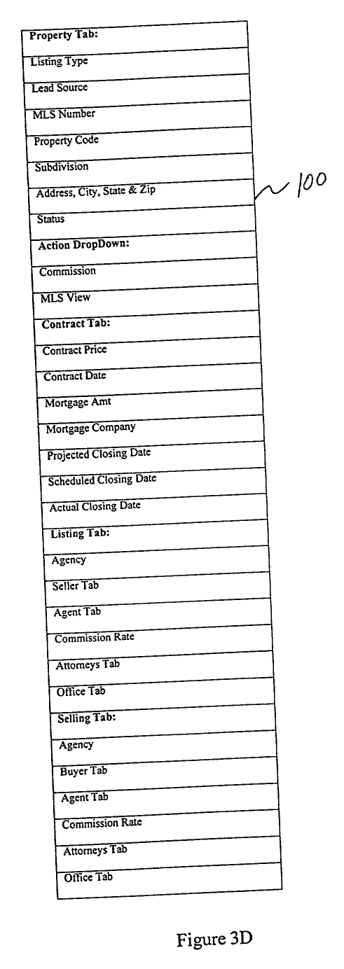

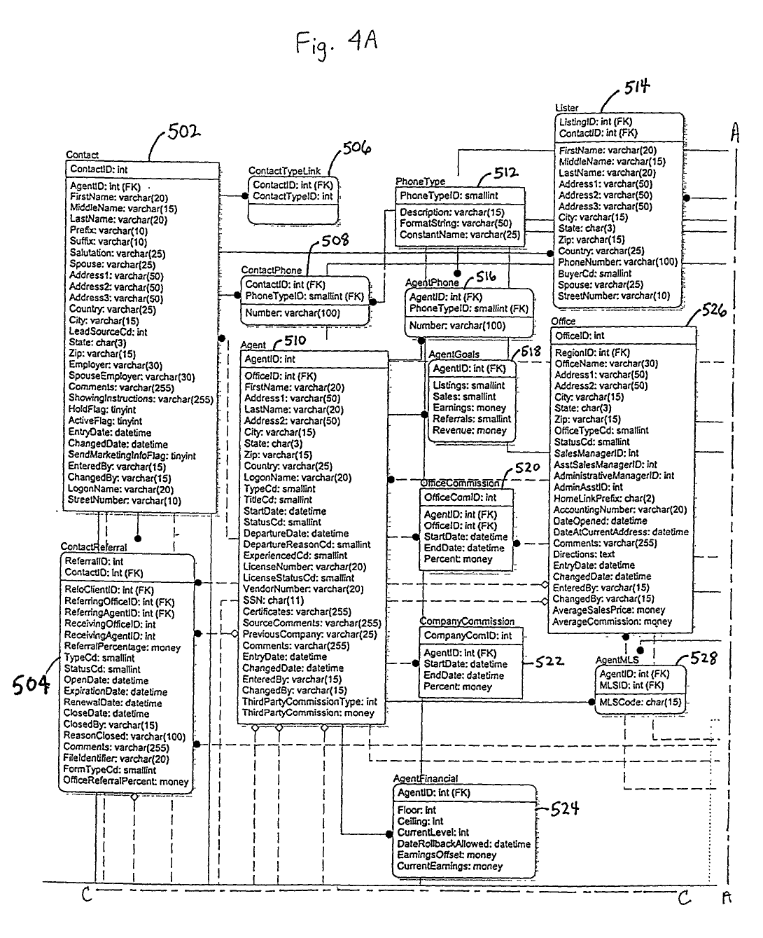

Referring now to FIG. 3A, an exemplary table 70 for defining roles is shown. The data entries in table 70 can be interpreted as follows. For the SALES primary entity, an agent has a default override permission of READ. For the COMMISSION RATE sub-entity (e.g., field), an agent has an override permission level of ADD. When a user has multiple roles, the permission level for any given entity will be determined factoring in all the roles the user has. Thus, the highest level the user has will determine the privileges allowed.

Preferably, the Listing System uses entity permission lookup via the Security object to determine the level of access for the user. In a preferred embodiment, a dynamic, table driven approach is applied. There are cases in which special business logic or custom code must be used in addition to or in lieu of basic lookup. For example, given that a user has access to certain functionality, it may be necessary to execute business logic to finally determine what data within that functionality that the user can actually view and update.

It is envisioned that several types of access may exist and the roles are defined. At a minimum, the following global NT domain groups are defined. Agents are those in the field that are responsible for obtaining listings of new homes, and attracting customers for buying homes. An Administrative Manager (“AM”) or AdminMgr is responsible for entering and updating MLS data in the MLS systems that each office uses. In another embodiment, a state may utilize multiple MLS systems. Each office may place listings in one or many of these MLS systems. Administrative Managers are also responsible for entry of information within the Listing System and handling local accounting functions such as bank deposits and record commissions in a pay out book. Sales Managers or SalesMgrs at each office are responsible for the overall operations of that office. Executive Management or ExecMgmnt include regional managers and officers of the real estate company. System Administrators or SysAdmin can access all functions of the system and all data for modification. Personnel or HRDept are responsible for employee and agent information. Compensation or CompDept may form a complete accounting department responsible for agent compensation including without limitation payment of commissions. Customer Service or CustSvcs are responsible for operating integrated mailing programs such as the Pitney Bowes SMARTMAILER® program (available form Pitney Bowes Inc., One Elmcroft Road Stamford, Conn. 06926). Business Partners or AffilComps are related business units which provide ancillary services such as van lines and mortgages.

Referring to FIG. 3B, a table 80 indicates a list of securable entities within the Listing System for Contacts. Similarly, in FIG. 3C, table 90 illustrates a list of securable entities within the Listing System. Referring to FIG. 3D, a table 100 indicates a list of securable entities within the Listing System for Sales.

It is also envisioned that security Maintenance can be provided within the subject system and method. Access to the Listing System is controlled via standard NT Security for the definition of NT global groups. Security maintenance and group assignments will be done via the NT User Manager. In addition, the security table that defines permission overrides must be populated with data.

IV. Server Configuration

In a preferred embodiment, the architecture of server 12 is multiple servers in order to increase stability and enhance performance. For example, each server which comprises server 12 would consist of a PENTIUM® PRO 2000 processor (available from Intel Corporation, 2200 Mission College Boulevard, Santa Clara, Calif. 95052), 128 MB RAM and hard disk non-volatile memory large enough to support web files, an operating system, several applications and several databases. Preferably, WINDOWS NT® software (available from Microsoft Corporation) is the server operating system. It is envisioned that the web sites are created in HTML language utilizing VISUAL STUDIO® software version 6.0 (available from Microsoft Corporation) and remote access is facilitated by Mabry's FTP/X Control. TRANSACTION SERVER® software (available from Microsoft Corporation) allows developers to deploy server applications to facilitate the necessary transactions. MICROSOFT's SQL SERVER® software version 6.5 (available from Microsoft Corporation) is the database engine used by the Listing System. MICROSOFT INTERNET INFORMATION SERVER® IIS software (available from Microsoft Corporation) allows developers to customize the web sites. ERWIN® software version 3.5 (available from Logic Works, Inc. at 214 Carnegie Center, suite 112, Princeton, N.J. 08540) maintains current entity relationship diagrams for a Listing System database.

In a preferred embodiment, server 12 is configured as a combination of two servers configured with a Pentium Pro 200 with 128 MB Ram, a hard disk large enough to support web files and an operating system such as Windows NT Server. The first server of server 12 runs a Microsoft SQL Server 6.5 installation for housing multiple databases including, without limitation, a Listing System, a Great Plains Accounting and other smaller databases. Second server of server 12 runs Microsoft Internet Information Server (IIS) 4.0 and Microsoft Transaction Server (MTS) 2.0 to further enhance performance and stability. In yet another embodiment, a third server may be incorporated into server 12 to house a Listing System to further increase performance and stability.

V. Databases

In a preferred embodiment, the memory of the servers stores a multiplicity of databases. It is envisioned that the databases are created utilizing MICROSOFT SQL SERVER® (available from Microsoft Corporation). The databases contain data relating to advertising, sales agents, contacts, listings, vendors, and the real estate company.

It is envisioned that advertising databases relate to advertising copy, advertising companies, advertising placements and advertising requests by contacts and sales agents databases relate to sales agents, agent financial information, appointments, agent goals, goal weighting, agent MLS codes and agent phone numbers. Databases for contacts preferably consist of tables relating to contacts, contact mailings, contact referrals and contact types. Listing databases preferably relate to listings, listing agent, listing MLS, lock boxes, MLS, MLS data, open house requests, picture references, garages, new home referral fees and showing information. Vendor databases preferably relate to relocation companies, relocation fee percentages, relocation company phone numbers, signs, sign vendors, mailings to vendors and the like. Real estate company databases preferably consist of attorneys, commission splits, company commissions, forms, types of mass activities, report tables, sale transactions, sales agents, sale commissions, sale contact, security, sellers attorney, offices, office commission fees, office MLS, office phone, regions, region commissions, surveys, survey choices, survey questions, survey response, system identifiers, system tables, trustee tracking, user messages, user roles and user sessions.

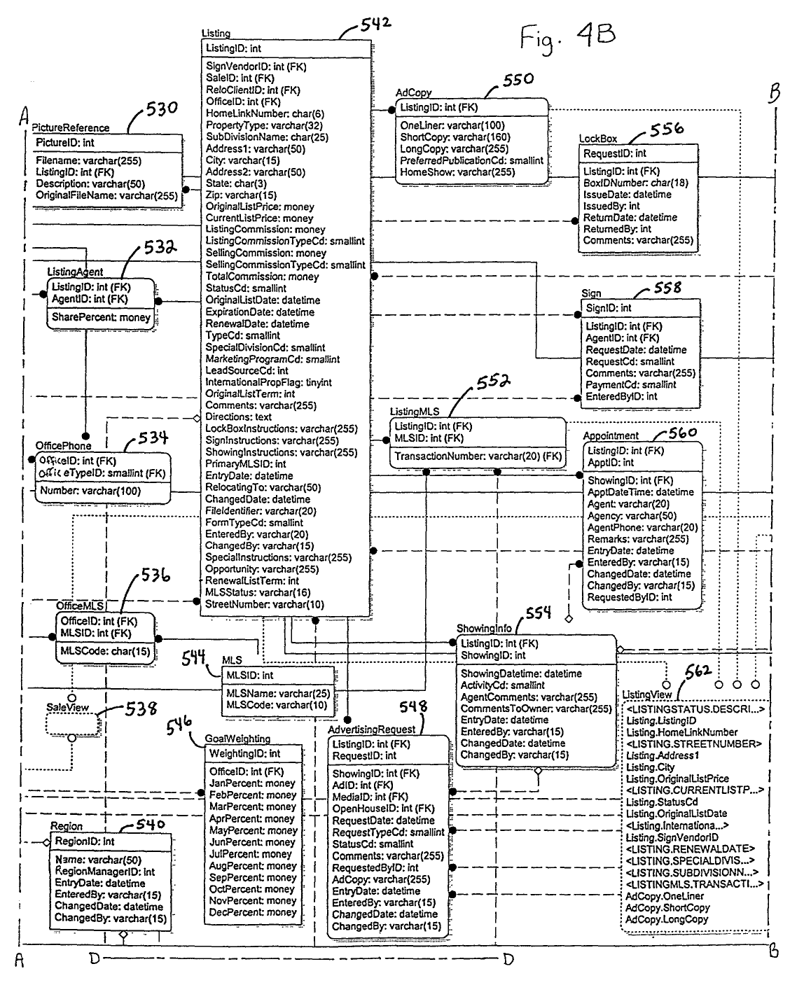

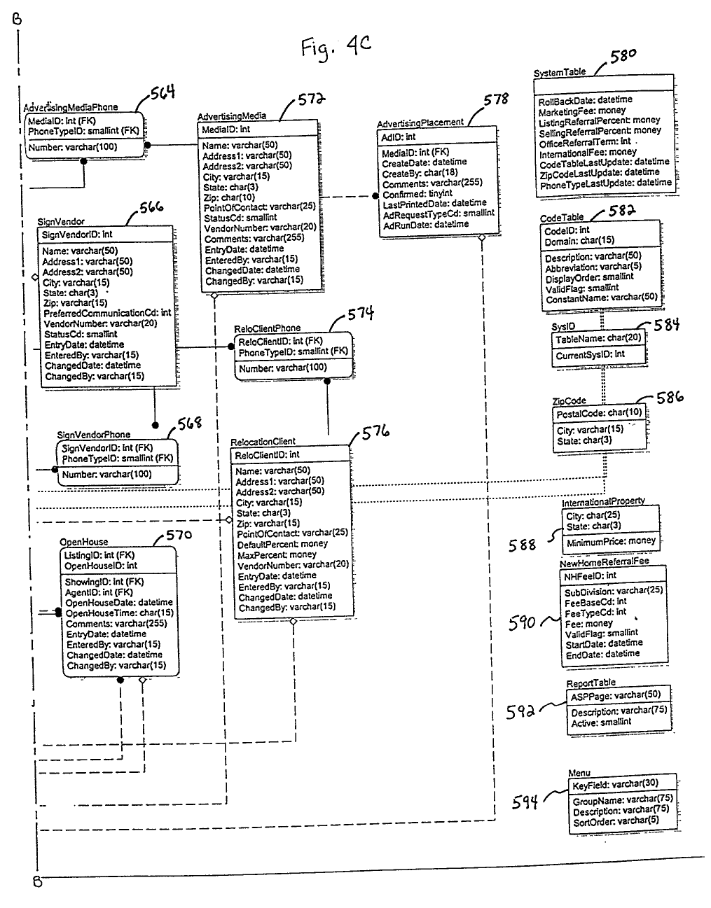

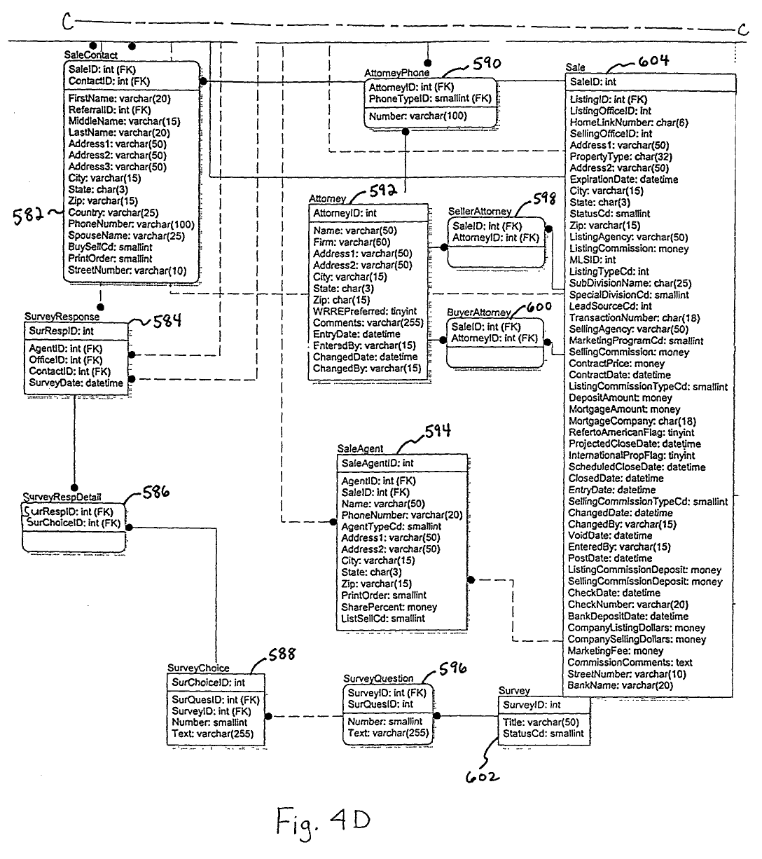

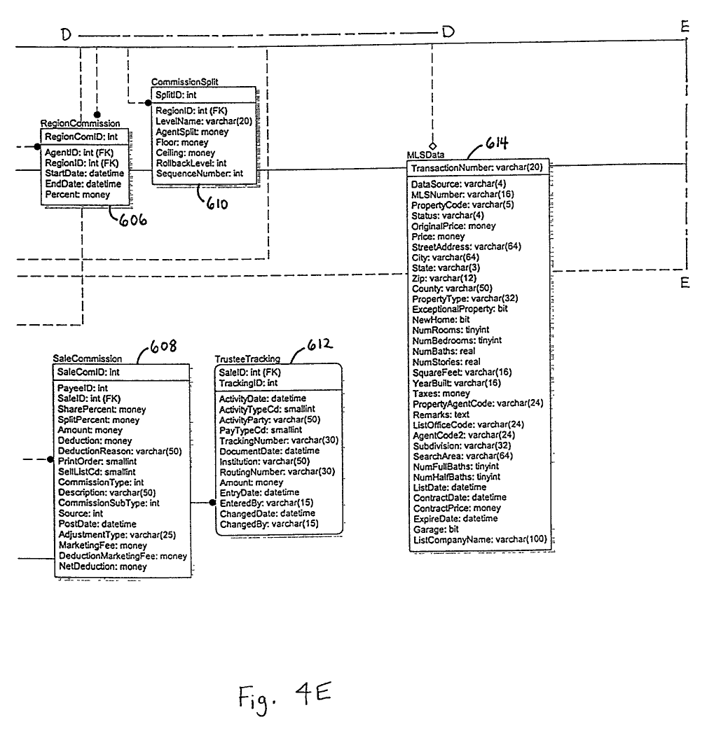

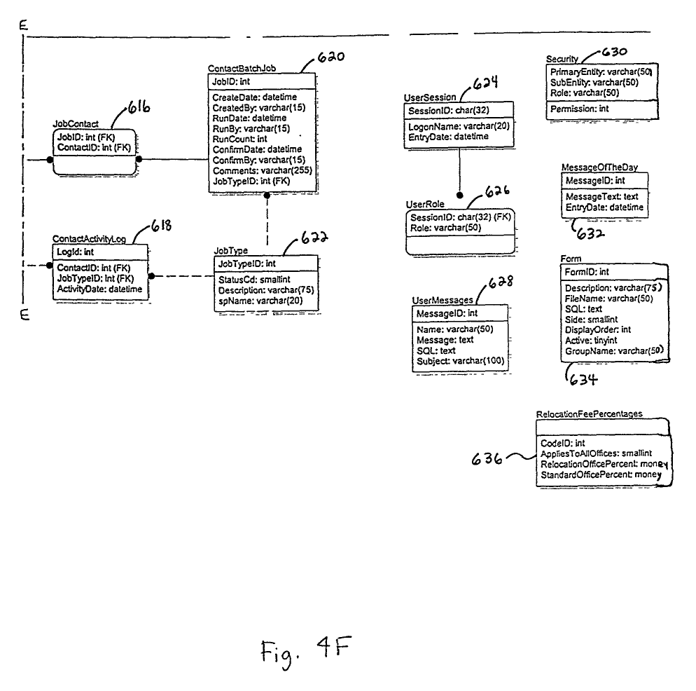

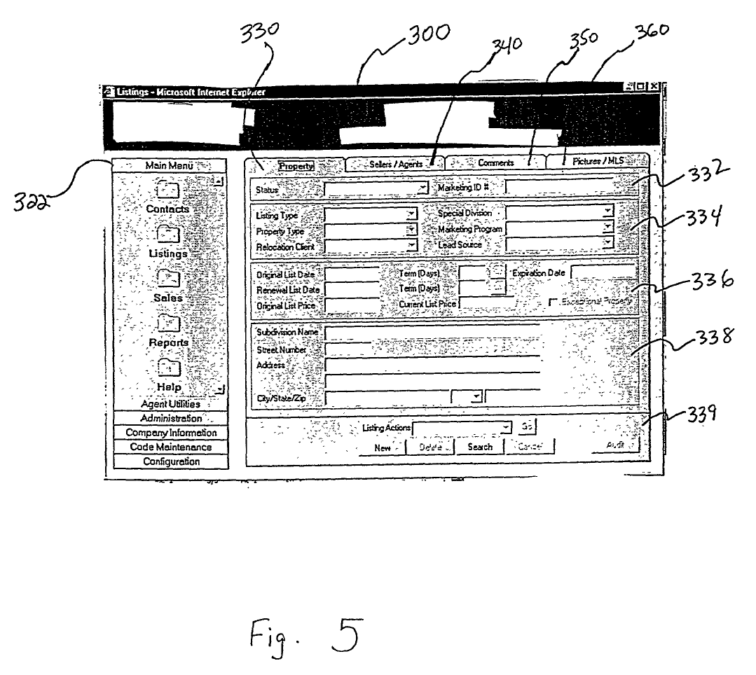

In a preferred embodiment, the databases are used in a relational arrangement so that they relate to one another by way of fields that store common data. Preferably, a system in accordance with the subject disclosure has data as shown in FIGS. 4A-4F. Each of FIGS. 4A-4F are related to each other by dashed matching lines A-A through E-E. The dashed matching lines allow FIGS. 4A-4F to be assembled to illustrate the interrelationship between the input fields shown within each figure. Adjacent to each variable name is a classification for the type of variable which the variable is.

FIG. 4A illustrates the fields as they can be input for Contacts 502, Contact Referrals 504, ContactTypeLink 506, ContactPhone 508, Agents 510, PhoneType 512, Lister 514, AgentPhone 516, AgentGoals 518, OfficeCommissions 520, CompanyCommissions 522, AgentFinancial 524, Office 526 and AgentMLS 528. A Contact 502 is a person who does or may do business with the proprietor of the subject invention. Contact Referrals 504 identify the agent referring the contact and information about the referral. ContactTypeLink 506 identifies the types of contact. ContactPhone 508 is a phone number for a contact. An Agent 510 is a person who may sell real estate for the proprietor. PhoneType 512 documents the types of phone numbers. Lister 514 is the contact placing a Listing with the proprietor. Information regarding the Lister 514 is captured and duplicated at the time the contractual documents are printed. AgentPhone 516 is a phone number for the agent. AgentGoals 518 are the business goals for the year for an agent. OfficeCommission 520 is a commission percentage information by Office for office management personnel. AgentFinancial 524 is information about the relationship between the agent and the proprietor. AgentMLS 528 is the MLS code of an agent with a particular MLS. Office 526 is a business center for the proprietor located at a physical address.

FIG. 4B illustrates the fields as they can be input for PictureReference 530, ListingAgent 532, OfficePhone 534, OfficeMLS 536, SaleView 538, Region 540, Listing 542, MLS 544, GoalWeighting 546, AdvertisingRequest 548, AdCopy 550, ListingMLS 552, ShowingInfo 554, LockBox 556, Sign 558, Appointment 560 and ListingView 562. PictureReference 530 provides the location of the pictures for Listing 542. ListingAgent 532 is the agent responsible for making the Listing 542. OfficePhone 534 is the phone number for an Office. OfficeMLS 536 is the MLS code for a particular Office. Region 540 is a grouping of offices for reporting and management purposes. Listing 542 is information about a home listing or contract between a contact and the proprietor. MLS 544 is a multiple listing system. GoalWeighting 546 provides monthly percentage weighting used to calculate an agent's progress toward their AgentGoals by Office. AdvertisingRequest 548 is a request by an agent for an advertisement to be placed with an advertiser. AdCopy 550 is the text that will be used when placing an advertisement. ListingMLS 552 is the MLS(s) with which the Listing is recorded. ShowingInfo 554 is the information collected about the showing of a Listing. LockBox 556 is activity about a lock box for a Listing. Sign 558 is the information about a sign for a Listing. Appointment 560 is a scheduled showing of a Listing for an agent. Saleview 538 is data relating to a posted sale. ListingView 562 is data relating to the pictures of a Listing.

FIG. 4C illustrates the fields as they can be input for the variables of AdvertisingMediaPhone 564, SignVendor 566, SignVendorPhone 568, OpenHouse 570, AdvertisingMedia 572, ReloClientPhone 574, RelocationClient 576, AdvertisingPlacement 578, SystemTable 580, CodeTable 582, SysID 584, ZipCode 586, InternationalProperty 588, NewHomeReferralFee 590, ReportTable 592 and Menu 594. AdvertisingMediaPhone 564 is a phone number for an AdvertisingMedia. Sign Vendors 566 are companies that can place a sign for a listing. SignVendorPhone 568 is a phone number for a Sign Vendor 566. Open House 570 is a request to hold an open house for a listing by an Agent 510. AdvertisingMedia 572 is a company with which advertisements may be placed. RelocationClient 576 is a relocation company that the proprietor engages in business. ReloClientPhone 574 is the phone number for a RelocationClient 576. AdvertisingPlacement 578 is a group of AdvertisingRequests with an AdvertisingMedia. SystemTable 580 contains the system wide information which may be a database table.

FIG. 4D illustrates the fields as they can be input for the variables as follows: SaleContact 582, SurveyResponse 584, SurveyRespDetail 586, SurveyChoice 588, AttorneyPhone 590, Attorney 592, SaleAgent 594, SurveyQuestion 596, SellerAttorney 598, BuyerAttorney 600, Survey 602 and Sale 604. SaleContact 582 is a contact who is buying or selling real estate. SurveyRespDetail 586 is a contact's response to a survey question. SurveyResponse 584 is a contact's response to a survey. SurveyChoice 588 is a multiple choice selection list for a SurveyQuestion 596. AttorneyPhone 590 is a phone number for an Attorney 592. Attorney 592 is a person who handles the legal matters for a sale. SaleAgent 594 captures agent information for listing and selling agents for a Sale 604. SellerAttorney 598 is the seller's attorney. Surveyquestion 602 is a question on a survey. Sale 604 is information about a home sale or contract between contacts. Survey 602 is a questionnaire sent to contacts. BuyerAttorney 600 is an attorney who represents a buyer of real estate.

FIG. 4E illustrates the fields as they can be input for the variables as follows: RegionCommission 606, SaleCommission 608, CommissionSplit 610, TrusteeTracking 612 and MLSData 614. CommissionSplit 610 is the commission levels and splits for a Region. SaleCommission 608 is commission information for a Sale 604. TructeeTracking 612 is information about money collected and disbursed by the proprietor for a sale. MLSData 614 is data from an MLS system.

FIG. 4F illustrates the fields as they can be input for the variables as follows: JobContact 616, ContactActivityLog 618, ContactBatchJob 620, JobType 622, UserSession 624, UserRole 626, UserMessages 628, Security 630, MessageOfTheDay 632, Form 634 and RelocationFeePercentages 636. ContactBatchJob 620 records the details about a mass contact activity. JobType 622 defines the types of mass contact activities. JobContact 616 includes a job identifier and a contact identifier. ContactActivityLog 618 includes data relating to transactions and interactions with contacts. UserSession 624 identifies sessions for which users utilized the subject invention. UserRole 626 characterizes the functionality available to a User during a session. UserMessages 628 receive and store communications from users. Security 630 contains the entity and sub-entity entries which define permission levels for users. MessageOffTheDay 632 receives and stores a quip for display to users and can be varied as often as desired. RelocationFeePercentages 636 stores commission splits between offices relating to contacts whose transactions involve multiple offices.

Primary inputs are put into the databases according to functional requirements, security, business rules and user actions as follows.

A. Contacts

Contacts 502 in the system are current or past customers, or potential future customers of the proprietor of the system. Contacts can be associated with property listings and property sales. In addition, contacts will be used for integration with other systems for future marketing.

During entry of new contacts, existing contacts will be matched based on first name, last name and any phone number. Phone numbers and emails will be stored for each contact to allow for a large number of “communication” sources for each contact. Each communication source, e.g., home phone, business phone, pager, email and the like will be associated with a particular type to allow enforcement of business rules.

The business rules for contacts will be as follows. Prefix, first name, last name, home phone number and agent must be entered to save a contact. A contact associated with any external business objects, e.g., Listing Transaction, cannot be deleted. If the contact has a Contact Type of CoBroke Renter, CoBroke Seller, Cobroke Buyer or Cobroke Tenant the Send Marketing Information flag will be turned off automatically when the contact record is saved. If a contact has a contact type of Seller, Buyer, Renter, Tenant, Outgoing Referral, or CMA Presentation Made, the contact is considered owned by that agent. Other Agents who cannot see a contact will not be able to view or edit a contact if one of the above contact types is checked. If a contact does not have one of the above contact types checked other agents will be able to access the contact record through the Add Contact control. The Created By, Created Date, Last Changed By, Last Changed Date are tracked for each contact.

For security, a contact can be updated by the agent that owns the contact, the AM or Sales Manager in the office in which the owning agent is assigned or System Administrators. Users have several available actions including the ability to: Add a new Contact; Update an existing Contact; Delete a Contact; Search for a Contact; Browse Contacts Transactions (includes Listing and Sales); Browse Contacts Activities; and Transfer Ownership.

B. Agents

Agents 510 in the system are Contractors or Employees that will initiate a Property Listing, Property Sell, Open House request, Advertisement request or Referrals. During entry of new agents, existing agents will be matched based on first name, last name and any phone number. Phone numbers and emails will be stored for each agent to allow for a large number of “communication” sources for each agent. Each communication source, e.g., home phone, business phone, pager, email, and the like will be associated with a particular type to allow enforcement of business rules.

The business rules for agents will be as follows. The following information must be entered to save an agent record: Status; First Name; Last Name; and Home Phone Number. In order for the Agent to become active, Type, Title, License Number, License Status, GPA Vendor Number, Primary Office, Commission Levels (Floor, Current, Ceiling), Address, City, State, Zip, SSN and NT Login must be entered. Each agent can have only one title. This title is used to associate them with job functions for each office, e.g., Agent, Sales Manager and the like. An agent associated with any external business objects, e.g., Listing Transaction, cannot be deleted. Agent information can be demographic information such as address and name. The AM or Sales Manager for the office for which they are assigned can update the agent information.

Compensation information can be updated by Executive Management. Agents can be assigned to one and only one office. In some cases where an agent has an affiliation with multiple offices, this affiliation can be documented in the comment section. Agent Goals based upon Listing, Sale and Referral data are limited to a value between 0 and 999. The Earnings Goal and Earnings Adjustment are limited to a value between 0 and 10,000,000.00. The Earnings can be calculated by the User Interface by multiplying Revenue Goal times Current Agent Split. The Revenue Goal is a read-only field that is updated when the agent record is saved or when the Office Average Sales price or Average Commission is changed. The calculation is as follows:

(((Agent Sale Goal+Agent Listing Goal)* Office Average Sales Price)* Office Average Commission)

For each agent an unlimited number of MLS codes can be entered. Each MLS will assign a code that represents a particular agent. These codes are used to identify that agent on the particular MLS. The Created By, Created Date, Last Changed By, Last Changed Date are tracked for each contact

For security, agent address, employment, phone and email information can only be updated by the personnel department. Agent Goals can be updated by Sales Managers for the office in which they are associated. Agent Commission information can be updated by the compensation department. System Administrators can maintain all information. Users have several available actions selected from the following: Enter a new Agent; Search for Agent; Update an Agent; and Delete an Agent. Agents have several available actions selected from the following: Browse Agents Referrals; Browse Agents Listing Transactions; Browse Agents Sale Transactions; Browse Agents Open House Request; and Browse Agents Advertisement it Request.

C Regions

The area covered by the proprietor is broken up into geographic regions 540. Each office is assigned to a specific region. The regions are used to set agent commission split levels. Commission split levels determine the agent split percentages based on agent earnings. During entry of new regions, existing regions will be matched based on region name. During updating of existing regions, duplicate regions will be matched based on region name. A commission split level has a unique range of earned dollars for which it applies.

The business rules for regions will be as follows. The Created By, Created Date, Last Changed By, Last Changed Date are tracked for each region. Region managers must come from the appropriate list of managers. The commission split level must rollback to an existing lower level unless it is the first level. The ceiling of a commission split level must be greater than the floor. The floor of a commission split level must be equal to the prior levels ceiling +1 unless it is the first level, then it must be 0.

For security, region information can be maintained by the compensation and system administrators. Users have several available actions selected from the following: Enter data for a Region; Update data for a Region; Delete data for a Region; and Search for an Region.

D. Offices

Offices 526 in the system are the unique identifiers for each physical office location or represent different departments within the proprietor's organization, e.g., Relocation, New Homes, and the like. Each Agent and Employee in the system is assigned to one and only one office. During entry of new offices, existing offices will be matched based on office name. During updating of existing offices, duplicate offices will be matched based on office name. Phone numbers and emails will be stored for each office to allow for a large number of “communication” sources for each office. Each communication source, e.g., business phone, fax, email, and the like will be associated with a particular type to allow enforcement of business rules.

The business rules for offices will be as follows. Offices have the following statuses: Incomplete, Open, and Closed. Where Incomplete means a new office that does not have all the information needed to complete transactions, Open means an office has all the necessary information to complete transactions and Closed means manually closed. Once an office is in Open Status, it cannot be reverted to an incomplete status as this can affect in process transactions. To save an office, an Office ID (system assigned) and Office Name must be entered. The following must be entered to save an office record to Complete status: Office Name; Address; Home Link ID; Accounting Location; and Region ID. The summation of monthly sales goal percentages must equal exactly one hundred percent. The Office Listing, Selling, Referral and Earnings Goals are all rolled up from the agents assigned to that office. None of these values are stored in a database. For each office, an unlimited number of MLS codes can be entered. Each MLS will assign a code that represents a particular office. These codes are used to identify that office on the particular MLS. An unlimited number of managers can be given overrides for sales within an office. To create a valid entry, the manager, start date, end date and percentage of override must be entered. The Created By, Created Date, Last Changed By, Last Changed Date are tracked for each office.

For security, office address and personnel information can be maintained by the personnel group. Office commission information can be maintained by the commission group and the System Administrator can maintain all office information. Users have several available actions including the ability to: enter, update, delete and search for an Office; Browse Office Listing Transactions; Browse Office Sale Transactions; Browse Office Referrals; and enter, update and delete Manager Overrides.

E. Listings Transactions

Listings 542 are a contract with a contact to list their property with the proprietor. A Listing is owned by an office and cannot be edited by agents other than agents associated with the listing. Each listing is entered when there is intent to sign a listing contract and the forms should be generated so that the listing contract (e.g., one of the forms) can be signed by the homeowner. Listings are entered without a corresponding MLS number. A user interface will exist for an Administrative Manager to match open listings without MLS numbers against MLS properties. The Administrative manager will have to select which MLS to locate the corresponding property within. For each Listing, an unlimited number of pictures can be associated. Users will be able to upload pictures. Pictures will not be printed on any reports or forms. Picture formats must be supported by Internet Explorer 4.0.

The business rules for listing transactions will be as follows. To save a Listing, the following must be entered: Property Address including: address, city, state and zip code; At least one seller (must be a valid contact); At least one agent (must be a valid, active agent); Original List Date; Expiration Date; Original List Price; Total Commission; Listing and Selling Share of commissions; and Listing Type. Property Type (unless it is a non-MLS entry, then it is manually entered), Sub Division Name (unless it is a non-MLS entry, then it is manually entered), and Current List Price (unless it is a non-MLS entry, then it is manually entered) come from the MLS data. The Listing ID, Created By, Created Date, Last Changed By, Last Changed Date, Terms, and Listing Office (based on the AM or Agent entering the Listing) are auto populated. The Listing Commission, Listing Commission Type, Selling Commission and Selling Commission Type are from default values in the registry. Each listing is owned by one and only one office. An agent can be listed only once on the Listing.

A seller can be listed only once on the Listing. Only active agents can be listed. Listings that need to be canceled are not removed, but the status is changed. Listing Statuses are selected from the group of Open, Under Contract, Closed and Canceled. If a contact is selected and the listed property address is not entered, the system prompts the user to default the contacts address. Each property may have an unlimited number of sellers. For each seller, a spouse can be entered. The spouse from the corresponding contact record will be defaulted. Current list price defaults to original list price. Current list price is updated from the MLS system. The commission can be based upon a percentage or flat fee. For percentages, the percentage must be greater than 1% and less than 15%. For flat fees, the flat fee must be greater than zero and less than the selling price. There are List Types selected from the group of Exclusive Right to Sell, Open Agency and Exclusive Agency. The List Types determine which contracts are printed. There are Special Divisions selected from the group of International, New Homes and Relocation.

Under relocation listing circumstances, Relocation Client, File Number, Special Instructions, Opportunity and Form Type are also captured. The Created By, Created Date, Last Changed By, Last Changed Date are tracked for each listing. The International PropFlag is true if the property is an International Property. International Properties are determined based on their city, state and list price. The International Property Table contains a list of cities, states and minimum list prices that would qualify a property. The original list price on the Listing Record is used to qualify as an International property. The picture files that are added to a listing are first written to a temporary directory of the FTP server.

Upon successfully updating the database (i.e. writing rows to the PictureReference table), the temp files will be deleted and the files written to the permanent repository as defined by the administrator. This repository can be on a different machine from the FTP server. The administrator should set up shares for the permanent repository directory and the temporary area directory, although this is not required. The registry will contain required values such as the FTP server machine name. This value is used for the initial upload and for deleting files from the temporary area. The share name or LJNC name is for the permanent repository directory. This value is used for moving files to and deleting files from the permanent repository. The share name or LJNC name for the temporary area directory is used for moving and deleting files from the temporary area. The permanent repository machine name is used for moving files to and deleting files from the permanent repository. The relative path for the temporary area from the root or default current directory of the FTP is used in file uploads. Permanent picture files will use the PictureReference table Picture ID column value and the original file extension as the filename. Only files with .jpg and .gif extensions are to be stored. Alternatively, different types of files can be stored. The original and repository name of the file are stored in the PictureReference table. When rows in the PictureReference table are deleted, the files pointed to in the repository are deleted. If a user uploads files and then cancels without updating, the files are deleted from the temporary area.

For security, listings can be updated by Agents associated with the listing. Only certain fields can be updated such as Sellers, Relocation information, Directions and Comments. Administrative managers and Sales Managers associated with the office in which the listing was taken can update all information on the listing. System Administrators can update all listings.

User have several available actions as follows: enter, update, delete and search Listings; enter, update, delete and view Appointments; enter, update, delete and view Open Houses; enter, update, delete and view Advertising; enter, update, delete and view Signs; enter, update, delete and view Lock-box; enter, update, delete and view Show Info; enter, update, delete and view Ad Copy; View MLS Data; and Load pictures of the property.

F. Sale Transaction

Sale Transactions are contracts for the proprietor customers to purchase homes listed by the proprietor or other agencies. Sale transactions may or may not be associated with a proprietor listing. Commissions are a significant part of the sale transaction.

The business rules for sale transaction will be as follows. Property Address including: address, city, state and zip code, Valid MLS # (or “None” for a non-MLS entry), at least one buyer but not more than five (must be a valid contact) and at least one seller but not more than five (must be a valid contact) must be entered to save a sale transaction. Listing Agency values can come from the MLS, can be entered by hand, or in the case of a proprietor listing are taken from the Listing Transactions. Selling Agency values are manually entered, or in the case of a proprietor sale they are the current office. Listing Agents equal at least one agent but no more than five. If the circumstances are a proprietor listing, then the associated listing is default information. If the circumstances are a co-broker listing, at least one listing agent with complete information must be provided. There must be at least one Selling Agent but no more than five. If sold by a proprietor agent, selecting from a list of agents defaults this information. If a co-broker, must select at least one listing agent and provide complete information including Contract Date, Contract Price rounded to the nearest dollar and greater than zero, Listing and Selling Share of commissions, Listing Type and Projected closing date.

The following fields are autopopulated from the MLS data: MLS Status, Expiration Date, Property Type, Sub Division Name, Sale ID, Created By, Created Date, Last Changed By, and Last Changed Date. A listing agent can be listed only once on the Sale. A selling agent can be listed only once on the sale. A seller and buyer can each be listed only once on the sale. Sale transactions cannot be deleted, but the status can be changed. When a sale transaction is created, if it is linked to a Listing record, the status of the listing record changes from Open to Under Contract. If the sale transaction is canceled, the corresponding listings status is changed to open.

If the sale transaction is closed or posted, then the corresponding listing record is closed. If a Sale is associated with a proprietor, Listing, or MLS record, the address fields cannot be updated. Sale Status options include Under Contract, Closed, Canceled and Posted. If a contact is selected and the listed property address is not entered, the user is prompted to use the contacts address. If a proprietor agent is selected for the listing or selling side of a sale transaction and no office for that side of the transaction has been selected the user is prompted to use that agents office. Each property may have an unlimited number of buyers and sellers. For each buyer and seller a spouse can be entered. The spouse from the corresponding contact record will be defaulted. List Types, which determine which contracts are printed, are selected from the Exclusive Right to Sell, Open Agency and Exclusive Agency. Special Divisions are selected from International, New Homes and Relocation. Deposit amount is a read-only field, cumulative from the trustee amounts.

There can be up to five Sellers or Buyer Attorneys. Seller and Buyer attorneys must be valid attorneys in the listing system. Contact types will be changed automatically from Prospective <Contact Type> to <Contact Type> when a contact becomes involved in a sale. When the sale is closed, the contact type will automatically be changed from <Contact Type> to Past <Contact Type>. The Sale Listing Type will determine the Contact Type that is changed. A Listing Type Of Exclusive Right To Sell will be Renters/Tenants Contact Types. All other Sale Listing Types will be buyer and seller Contact Types. Cobroke Contact Types will be used for the buyers and sellers if the associated side of the sale transaction is not a proprietor transaction. When a Sale is closed and a Cobroke is involved, the involved Cobroke contacts will be made Past Cobroke <Contact Type> and the Send Marketing Information flag will be set for the contacts. The Created By, Created Date, Last Changed By, Last Changed Date are tracked for each Listing.

For security, sale transactions can be updated by Agents associated with the sale, but only the sellers and buyers fields can be updated. Administrative Managers and Sales Managers associated with the office in which the sale was taken can update all information relating to the sale. System Administrators can update all sales. User have several available actions as follows: enter, update, delete and search Sale Transactions and enter, update and delete Trustee Amounts.

G. Commissions

The final step in the sales transaction is the calculation of commissions. Agent Commissions are determined based on many parameters including: selling price of the home; agreed upon splits between the selling and listing agents; agreed upon commission shares between multiple agents on the selling side and listing side; current commission splits for agents based on earning schedules; marketing adjustment; and miscellaneous adjustments. Manager commissions are determined based on many parameters including without limitation: Agent commissions; and Predetermined percentages per office. Interfaces must be available to handle office commissions, international referrals and relocation referrals and adjustments.

The business rules for commissions will be as follows. When a sales transaction is posted, or when an adjustment is applied, the agent earnings “bucket” must be updated accordingly. Commission Splits are table driven and based on region. There can be an unlimited number of split-levels. When posting sale transactions, the listing side is posted before the sell side. The agent commission splits must be recalculated from the list side before posting the sale side. Managers are associated with an office, region or the company. Each manager will have a defined period and percentage for that period. Manager commissions will be paid out if the closing date of the sale falls within the defined time period. If an office is involved in a sale the Office managers and Regional managers for that Office and the Company managers will all get a percentage of the commissions.

Commission calculations will be done in a spreadsheet view with tabs corresponding to the major commission areas (not shown). In a preferred embodiment, the Sale Detail tab of the spreadsheet will contain Contract price, Marketing Fee, Listing and Selling commissions. The Office tab of the spreadsheet will contain detail commission information for the Offices, Agents and Managers for both the listing and selling side of the sale. The Agents will get commissions based on their current commission level unless there is a third party contact referral for this listing with a type of “Listing 3rd Party” in which case they will get a third party referral percentage as stored in the registry. The Selling Agent split will be adjusted based on the Agents listing commission if the Agent is also a listing agent. The Managers will get a commissions based on a value stored in the database for the defined management time period unless there is a third party referral for this listing with a type of “Listing 3rd Party” in which case they will get a third party referral percentage as stored in the registry. The Contact Referral tab of the spreadsheet provides information on contact referrals. Contact referrals are commissions paid to an Office or Agent when there is no third party (e.g., Relocation Client) involved in the contact referral.

Offices get a percentage of commissions based on a system wide value. The office referral percentage is different based on whether the contact is a listing or a selling contact. These values will be stored in the registry. The agents split will be based on the current commission level. The New Home Referrals tab of the spreadsheet provides information regarding new home referrals. A New Home Referral occurs if the listing involved in the sale has a Special Division code of “New Homes”. The Office with an office type of “New Homes” will get a commission based on the SubDivision which will be matched against the NewHomeReferralFee table. No agents get commissions for a New Home referral. Office, Region and Company managers will all get their standard commissions.

The Int. Property Referrals tab of the spreadsheet provides information regarding international property referrals. An International Property Referral occurs when the listing involved in the sale has the International Property box checked. The Office with an office type of “International Properties” will get a commission based on a system wide value multiplied by the sale price. No agents get commissions for an International Property referral. Managers will all get their standard commissions. The Third Party Referrals tab of the spreadsheet describes contact referrals with a Relocation Client assigned to the referral. If the Referral type is “Listing 3rd Party” the listing side of the commissions will be calculated differently. The Office with a type of “Relocation” will get the percentage defined in the referral. The referring employee or agent will get a referral percentage or fee based on a third party fee type and amount in the employee's or agent's record. The managers get standard commissions. The Adjustment tab of the spreadsheet describes adjustments made after the commissions have been posted. The adjustment tab of the spreadsheet will have a column for the Office tab and each involved referral. No data will be populated into the adjustment tab, it will be the responsibility of the user to select the Offices, Agents or Relocation Clients (e.g., Third Party Clients) involved in the adjustment and correctly enter the amounts. There can be a variable number of adjustment tabs.

For security, Administrative Managers and Sales Mangers associated with the office in which the sale was taken can update all information on the commission. System Administrators can update all commission data. Users have several available actions as follows: Commission calculations and maintenance for Office Commissions, International Referral Commissions, Relocation Referral Commissions, and Adjustments. Commissions are posted to a Great Plains Accounting module.

H. Trustee Tracking

Trustee Tracking 612 records monies deposited or disbursed from a sales transaction. Typically, these are the deposits paid by the buyers. Trustee amounts are entered on sale transactions only. The cumulative amount of trustee transactions is displayed on the Sale Transaction screen as a deposit.

The business rules for trustee tracking will be as follows. To save a record, Action Date; Type; Deposit; Disbursement; Received from/Payee; and Pay Type must be entered. Check/CC/Wire Number; Doc/Expiration Date; Drawn On; Amount; and Routing Number are optional. A running balance is calculated and displayed. The Created By, Created Date, Last Changed By, Last Changed Date are tracked for each trustee.

For security, Administrative managers and Sales Mangers associated with the office in which the sale was taken can maintain the trustee information. System Administrators can maintain all trustee information. Users can enter, update, delete, and search Trustee Amounts.

I. Attorney

Attorneys 592 in the Listing System are Attorneys that handle property settlements. During entry of new attorneys, existing attorneys will be matched based on first name, last name and any phone number. Phone numbers and emails will be stored for each attorney to allow for a large number of “communication” sources for each attorney. Each communication source, e.g., business phone, pager, email, and the like will be associated with a particular type to allow enforcement of business rules.

The business rules for attorneys will be as follows. First name, last name, firm, address, city, state, zip code and business phone number must be entered to save an attorney record. An attorney associated with any external business objects, e.g., Listing Transaction, cannot be deleted. An Attorney can be updated by Administrative Manager or Sales Manager in the office in which the owning agent is assigned, the Executive Management, and the System Administrator. The Created By, Created Date, Last Changed By, Last Changed Date are tracked for each attorney. The proprietor preferred flag for each attorney has no business rules associated with it.

For security, Administrative managers, Sales Managers and System Administrators can maintain Attorney information. Users have several available actions as follows: Enter a new Attorney; Update an existing Attorney; Delete an Attorney; and Search Attorneys.

J. Referrals

Contact Referrals in the Listing System are referrals of a contact by an agent or employee to another the proprietor office. Certain Functional Requirements apply as follows. The agent or employee may refer a contact to an agent in the referred office, or to the office itself. If an agent is not specified then the Administrative manager for the referred office can assign the referral to an agent in the office. Referral Types provide a guide to the referred office of what the referred contact is interested in. For example, for a “Listing” the referral is interested in Listing a home, for a “Buying” the referral is interested in buying a home and for a Listing Opportunity the contact wants a “BMA” (Broker Market Analysis) and may want to list the home. For a No-Listing Opportunity the contact wants a BMA but has no plans to list the home (this is commonly done as part of a relocation, where the relocation company needs an assessment of the home). Several referral Statuses are possible. Open referral status means the referral was submitted by an agent. Expired referral status means the referrals have expiration dates. These are dependent on who submitted the status, e.g., agents or a relocation department. Lost Opportunity referral status means an office or agent deems the referral lost and closing comments must be provided. Assigned referral status is when a contact is associated with a closed sale transaction. Denied referral status is when the AM in the referred office rejects the referral. Closed by Referring Office referral status is if the agent or AM in the referring office declines the referral. A nightly process will be used to expire referrals. AM's (Administrative Manager's) view referrals sent by their office and sent to their office separately. Referrals can be filtered by status and sorted by date. This allows the Administrative Managers to see referrals that will expire shortly. Contact employer is an open text field. However, the relocation department will maintain a predefined list of employers.

This will provide some standardization of employer names to assist the relocation department in finding contacts that work customers of their relocation clients. For instance, if Company A has Company B as a customer, since Company A is a client of the relocation department if a contact buys a home through the proprietor and is employed by company B then the relocation department is owed a referral.

The business rules for referrals will be as follows. A contact may have multiple referrals active at one time, but the same agent must initiate all of the referrals. To be saved, Referring office and agent, Referred to Office, Open Date and Type must be entered. Referral Types of BMA-Listing Opportunity and BMA-NO Listing Opportunity are only valid if the referring agent is with the relocation department. When an agent sends a referral to an office, the agent can only assign it to an agent in that office. Assignment of an agent is optional. An Agent cannot change a referral once it is submitted. AM's can change the status to “Close by Referring Office” on referrals from their office only, and can change the status to “Denied” for incoming referrals to their office. If the status is changed to either of these, a reason must be provided.

When an agent creates a new referral, the expiration date is set to the Open Date plus the expiration term set per office for the office in which the referring agent is associated. Most offices are the same with the exception of other departments, e.g., relocation, mobility plus, and the like. The expiration date cannot be manually changed. The open date is defaulted to today's date, but can be changed to seven days prior to today. This assumes that people enter a referral within seven days of identifying the referral. The open date must be prior to the renewal date and the close date. The renewal date must be prior to the close date and after the open date. When updating a referral, the open date cannot be changed. The renewal date can be updated which changes the expiration date based on the referral term.

When an agent creates a new referral, the referral percentage is set to the referral percentage per the company. This is for non-relocation referrals only. Relocation referrals are created by the relocation department only, and the default referral percentage comes from the default referral percentage from the client record. The relocation agent can overwrite this value at the time the referral is treated, but cannot be less than zero or greater than the max from the client record.

For security, AM's and Sales Managers associated with the office in which the referral was sent from can maintain referrals sent from agents in that office. AM's and Sales Managers associated with the office in which the referral was sent to can maintain referrals sent to that office. Agents can maintain referrals they submit. System Administrators can maintain all referral information. Agents can Enter, Update or View a Referral and Offices can Enter, Update or View referrals from the office and to the office.

K. Relocation Clients

Relocation clients 576 are external companies that the proprietor partners with for managing corporate relocations. The relocation department of the proprietor manages these external companies. During entry of new clients, existing clients will be matched based on client name and point of contact. During updating of existing clients, duplicate clients will be matched based on client name and point of contact. Phone numbers and emails will be stored for each client to allow for a large number of “communication” sources for each client. Each communication source, e.g., business phone, fax, email, and the like will be associated with a particular type to allow enforcement of business rules. A default and maximum referral fee are captured and used in referral processing.

The business rules for relocation clients will be as follows. To save a client record, the following must be entered: Client ID (system assigned); Client Name; Point of Contact; Address; Business Phone; GPA Vendor Code; Default Percent; and Max Percent. The Created By, Created Date, Last Changed By, Last Changed Date are tracked for each client.

For security, relocation clients can only be updated by Agents and Administrative Managers in the relocation department. System Administrators can maintain all relocation client information. Users have several available actions including the ability to enter, update, delete, and search for an Client.

L. MLS Sources

Typically, the proprietor uses two primary Multiple Listing Services 544 (MLS), a state MLS and a private MLS. A property can be listed in one or many MLS's, therefore, the Listing System must be able to associate a MLS number with a MLS. During entry of new MLS Sources, existing MLS Sources will be matched based on the MLS name. During updating of MLS Sources, duplicate MLS Sources will be matched based on the MLS name. The only business rule applicable to MLS sources is that a MLS Name must be entered.

For security, System Administrators can maintain all MLS Source information. Users have several available actions with respect to MLS Sources including enter, update, delete, and search MLS Sources.

M. Contact Batch Jobs

Contact Batch Jobs 620 are used to collect contacts that will be exported to external systems such as the Pitney Bowes SMARTMAILER®. Batch jobs operate on a Job Type, e.g., Thank You Letter, which is associated to a predefined query or stored procedure. A user will create a Batch Job by entering a name and selecting a batch job type. They can run the batch job to get a count or collect the data.

The business rules for contact batch jobs will be as follows. A batch job must have a name and a job type. A job type cannot be changed once a batch job is created but if necessary, it may be deleted and recreated. Batch Jobs can be run many times until the Batch Job is confirmed. Once it is confirmed, the system will update the Confirm Date and confirm by field. Additionally, the ContactActivityLog is updated with the appropriate information. Running a Batch Job runs the predefined stored procedure and stores the count in the Run-Count column, and enters the Run-By and Run-Date info. It also creates the corresponding rows in the Job-Contact Table.

For security, those in the SMARTMAILER® Group and System Administrators can maintain all Contact Batch Job information. Users have several available actions including the ability to enter, update, run, and delete Batch Jobs. External feeds, preferably an external Microsoft Access database, are created that can interface with the SQL Server database. A stored procedure will exist that can take as a parameter the Batch Job ID and return the contacts that were selected as part of the Batch Job Run. Once this result set is returned to Access, the database can be exported to other external programs.

N. Contact Activity Log

The Contact Activity Log 618 keeps track of actions performed to Contacts. This may include such activities as sending a Thank You Letter or Survey as part of customer follow-up. Activities are entered as part of another process, e.g., pulling contacts for a mailing. The business rule for Activity Logs requires having the Batch Job ID, Contact ID, Activity Date and Job Type ID entered.

For security, those in the SmartMailer Group and System Administrators can maintain all Contact Activity Log information. User have several available actions as follows: form a contact record, view all activities associated with the contact; and form Batch Job Manager, view all contacts associated with that batchjob (This would be the ones were committed during the Job run).

O. Lock Box Information

Lock Box Information 556 Tracks Lock Boxes assigned to Listing properties. These would include only those properties listed by the proprietor. Administrative Managers will record lock box activity for listed properties. Lock box activity can be viewed after first selecting a listed property. This would be the primary way to check out a lock box to a property. An issued lock box can be found by searching for a lock box number. The search will only return a match if the specified lock box is currently checked out. This would be the primary way to check in a lock box. An activity entry tracks when a lock box is issued (and who it is issued to), and when it is returned (and who returned it). There may be multiple activity entry records. For example, if lock box A is issued and then returned because it is faulty, and lock box B is re-issued as a replacement, this results in two activity records. Each activity record contains the following fields for lock box information: Box ID Number; Uniquely identifies a lock box; Issue Date; Date lock box was issued; Issued To Agent; Agent lock box was issued to; Return Date; Date lock box was returned; Returned By Agent; Agent returning the lock box; Comments; and Associated comments (Mostly relevant for re-issue entries).

The business rules for lock box information will be as follows. A Lock Box Number is always required. A lock box can only be assigned out to one property at a time. An issue date is always required an entry can not be created until the lock box is issued. It will default to the current date on entry. The Issued To Agent field is always required and will default to the current agent on entry. The system will only allow a valid agent to be selected. Return Date can default to the current date via the user interface (“UI”) and is required if Returned By Agent is specified. Returned By Agent is required if a Return Date is specified and can default to the current agent via the UI. The system will only allow a valid agent to be selected. Comments are required on a re-issue and are optional otherwise. A new lock box can not be re-issued until the previous lock box is marked as returned. The system will ensure that the date fields on all entries are properly sequenced. Return Date must be greater than or equal to the Issue Date. Re-Issue Date must be greater than or equal to the prior record's Return Date.

For Security, AM's and Sales Mangers associated with the office in which the listing was taken can maintain all lock box information. System Administrators can maintain all lock box information as well. Users have several available actions such as the ability to view Lock Box information for each listed property, search for an issued lock box, and enter, update and delete lock box entries.

P. Ad Copy

Ad Copy 550 is used for placing advertisements on listed properties. The actual advertisement is initially entered through the Ad Request screen and approved through the Ad Placement Screen. The business rules which apply to ad copy are as follows. Ad Copy is associated with a Listing Record. There can be only one Ad Copy Record per listing, this means one of each of the following per Listing: One Liner (max characters 75); Short Copy (max characters 150); Long Copy (max characters 255); and Home Show (max characters 255). Any of the Ad Copy values can be empty. If there is a corresponding Ad Copy record then data will be updated, if not a new Ad Copy record is inserted. Once an Ad Copy record is created for a Listing Record, it is never deleted until the Listing Record is deleted. Preferred publication is enabled only if the property is an International Property. International Properties are determined based on their city, state and list price. The International Property Table contains a list of cities, states and minimum list prices that would qualify a property. The original list price on the Listing Record is used to qualify as an International property. The preferred publication can be set to none.

For security, Ad Copy for a listing can be updated by Agents associated with the listing. AM's and Sales Mangers associated with the office in which the listing was taken can update ad copy information. System Administrators can update all listings. Users have several available actions as follows. If Ad Copy is activated from a Listing, then that current listing is set as the active Ad Copy record. If Ad copy is activated from the menu bar, then no current listing is set as the active Ad Copy record. Upon entering the Ad Copy screen, all current and active listings to which the user has access to are made available by the drop down list. From the Ad Copy screen a user can enter or update Ad Copy information.

Q. Sign Vendor

Sign Vendors 556 in the Listing System are companies that place For Sale and For Rent signs on the proprietor Listed properties. During entry of new sign vendors, existing sign vendors will be matched based on company name and any phone number. Phone numbers and emails will be stored for each sign vendor to allow for a large number of “communication” sources for each sign vendor. Each communication source, e.g., business phone, pager, email, and the like will be associated with a particular type to allow enforcement of business rules.

The business rules for sign vendors are as follows. The following information must be entered to save a sign vendor: Name, Address, City, State, Zip, Preferred Communication and GPA Vendor ID. The Created By, Created Date, Last Changed By, Last Changed Date are tracked for each Sign Vendor. Sign vendors cannot be deleted if any sign activities are associated with them but they can instead be made inactive. Preferred Communication List should be a list of communication types for which entry has been made for this Sign Vendor. For example, if this vendor only has a business phone and fax, then the preferred communication list should only have these to choose from. No preferred communication can be a valid option, in this case when an sign action is requested, a message will be displayed to the user indicating that no preferred communication method has been selected.

For security, AM's, Sales Mangers and System Administrators can update sign vendor information. Users have several available actions including the abilities as follows: Enter a new Sign Vendor; Update an existing Sign Vendor; Delete a Sign Vendor; and Search for a Sign Vendor.

R. Signs

Signs 558, either for “sale” or “for rent” signs, are placed on properties listed by the proprietor real estate company. Predefined Sign Vendors perform the function of installing and removing these signs. Administrative Managers will request sign vendors to install, move or remove the proprietor signs. For each listed property, the Administrative manager can select a sign vendor and add, update and delete sign actions.

The business rules for signs are as follows. One and only one sign vendor can be selected for each listed property. Any sign actions will assume use of this single sign vendor. A sign vendor must be selected before any sign actions can be initiated. Since sign requests are communicated to the sign vendor, these cannot be updated once they are saved. If you want a change, enter a new record with a different service request or the same service request with new comments. Services that can be requested include the following: Installation which is to install a sign at a property; Move which is to move a previously installed sign on a property; Remove which is to remove a previously installed sign from a property; Repair which is to fix the existing sign; and Sold which is to add the sold banner to the existing sign. The sign fields require an installation date, service requested, requested by, Issued By (System Generated) and Payment Type (Either company or agent). Comments are optional. Once a sign action is entered, the system will attempt to communicate with the sign vendor by the “Preferred Communication” method selected on the sign vendor maintenance screen. If no Preferred Communication method has been selected, a message will be displayed to inform the user. Email and Fax methods of communication with sign vendors are supported. The information to the sign vendors sent will be similar to the Sign Request Form which includes: Vendor Name, Fax number, Phone number, the proprietor Office, the proprietor Administrative Manager, the proprietor Fax number, the proprietor Phone number, Date, Agent, Owners, Property Address, Directions to property, Color & Style of House, Service requested, comments, placement instructions.

For security, agents associated with the listing can update sign information. AM's and Sales Mangers associated with the office in which the listing was taken can update sign information. System Administrators can update all listings. Users have several available actions including the abilities as follows: Enter, update, Delete Signs; View Sign Activity for each listed property; and, from the Sign Action screen, allow easy selection of listed properties per office to avoid having to do a full listing lookup. External System Feeds May communicate with sign vendors by email or fax.

S. Advertising Requests

Advertising Requests 548 are made by Agents and Approved by Administrative Managers. All advertising requests can not be accommodated, so an approval process should be implemented. An agent for a specific property can initiate advertising requests. Advertising requests can be initiated by other processes, e.g., Open House Requests.

The business rules for advertising requests will be as follows. Agents can only request advertising on listings for which they are one of the listing agents. Multiple advertising requests can be made on one listing at a time, but advertising request of the same Request Type cannot be made for the same date. Ad Request ID, DOE, Entry By, DOC, Change By are system generated. Request Date, Request Type, Status (system controlled) and Ad Type codes must be entered to save an Ad Request. Comments are optional. Agents can resubmit an advertising request if it was denied. There is no limit to the number of times a request can be denied and resubmitted. If an advertising request is initiated because of an open house request, the link to the open house ID is stored in the advertising request record. The following rules apply to open house advertising requests. If an open house is canceled or the date is moved, the advertising requested must be updated accordingly. If the advertising request is denied, the open house record must be updated accordingly. An Open House request type cannot be changed to another request type. Once the status is set to Placed, the record cannot be updated or deleted. Updating a record that has a status set to “denied” causes the status to be reset to “pending”.

For security, Agents associated with the listing can update advertising requests. AM's and Sales Mangers associated with the office in which the listing was taken can update advertising requests. System Administrators can update all listings. Users have several available actions according to their classification. Agents can enter, update and delete advertising requests and view advertising from each listing or all requests for one agent. Administrative Managers can approve or deny advertising requests.

T. Advertising Placement

Advertisement Placement 578 is a process used by the Administrative Managers to organize advertising requests for placement in various advertising media. The Administrative Manager will have an interface for creating the advertising information that is sent to each media company. For example, if an administrative manager wants to advertise classified ads in a local newspaper, then the AM has to select ad requests for media type of Classified Ads. The steps are: (1) Select the Ad Requests by Media Type; (2) Select the Media company (e.g., from active Media Companies); (3) Select the ad copy for each of the selected properties; (4) Enter cover sheet information; and (5) Print out the collected information with an updated printed date on record.

Printing is accomplished with Microsoft Word. Using the 8.0 Object Library for Microsoft Word, Microsoft Word is started and the text of the package is derived from the ad requests included in the package. The listings are sorted by city and the ad copy of each request appears below the listing's address and current list price. The printed package is titled with the media company, request type and ad run date. Once the Media Company has received the ad placement package, the confirmed date is updated.

The business rules for advertising placement are as follows. The listed property is still an active property, i.e. no sale is pending or the listed property has not been removed from the market. Users work on one ad placement at a time for a particular office. The packages are created for listings where the office is one for which the user is either an administrative or sales manager. Each listing, as represented by an ad request, can appear only once per ad placement package. Once an ad placement package collection is created, it can be reprinted. Each time it is printed, the printed date is updated. Once an ad placement package collection is confirmed, it cannot be updated or deleted. The media request type, e.g., Classified Ad, cannot be modified. Since the collection began by group on request type this cannot be changed for a package. When an ad placement package is deleted, any ad requests linked to it will have the ad id set to null and their status set back to pending. New ad requests can be put into the package as long as they are the same request types as the package. Ad requests can be updated by changing the ad copy content. Ad requests can be deleted, which would change the status on the ad request record back to pending.

For security, AM's and Sales Mangers can maintain ad placements that affect ad requests for properties listed in the office for which they are associated. System Administrators can update all ad placements. Users have several available actions based upon their classification. Administrative Manager Interface can deny ad requests. The Administrative Manager Interface allows selecting ad requests and creating print ad placement packages. The Administrative Manager Interface also allows viewing ad placement packages and reprinting them.

U. Advertising Media

Advertising Media 572 represent the various media sources that advertising can be placed. During entry of new Advertising Media, existing Advertising Media will be matched based on company name, point of contact and any phone number. Phone numbers and emails will be stored for each advertising media company to allow for a large number of “communication” sources for each. Each communication source, e.g., business phone, pager, email, and the like, will be associated with a particular type to allow enforcement of business rules.

The business rules for advertising media are as follows. The following information must be entered to save a record: Name; Point of Contact; Address; City; State; Zip; and GPA Vendor ID. The Created By, Created Date, Last Changed By, Last Changed Date are tracked. A record cannot be deleted if any ad placements are associated with them, instead they can be made inactive. For security, AM's, Sales Mangers and System Administrators can update advertising media. Users can enter, update, delete and search for Advertising Media.

V. Open House Request

An Open House Request is requested by an Agent and approved by an Administrative Manager. An agent can initiate open house request for their listings only. The business rules that apply to open house requests are as follows. Agents can only request open houses on listings for which they are one of the listing agents. Multiple open house requests can be made on one listing at a time, but not for the same date. Open House ID, Date of Entry, Entry By, Date of Change, Change By, Open House Date, Open House Time and Ad Request Date must be entered to save an Open House Request. Open House, Date of Entry, Entry By, Date of Change, Changed By and Change By are system generated. Comments are optional. Open House ID, Date of Entry, Entry By, Date of Change and Change By are system generated. When an open house request is saved, the following must be done: an ad request record with appropriate information must be created; a Show Info record with the Agent, Agency, and Phone number info dumped into the internal comment section must be created; and the ID of the newly created show info record in the Appt Record must be stored. If an open house is deleted, the user should remove the corresponding ad request record and the corresponding show info record. If the advertising request is denied, the open house record must be updated accordingly. When an ad request is accepted, i.e., the status is changed to “Placed”, a Show Info record is created. Once the status is set to Placed, the record cannot be updated or deleted. Updating a record that has a status to denied causes the status to be reset to pending.

For security, Agents associated with the listing can update open house requests. AM's and Sales Mangers associated with the office in which the listing was taken can update open house requests. System Administrators can update all listings. Users have several available actions based upon their classification. Agents can enter, update, and delete open house requests as well as view open house from each listing or all requests for one agent. Administrative Managers can approve and deny open house requests.

W. Showing Information

Showing Information 554 in the Listing System is an audit trail of all showings on the Listed properties. Some of this information will be available to customers via the Internet. Many business functions may be associated with Show Info, e.g., Open House and Advertisement Placement. Show Info records can be entered by agents for the purpose of highlighting activity on the property to the property owner.

The business rules for showing information are as follows. Show Date, Show Time, Show Info Activity Type, Agents Comments, Date of Entry, Entry By, Date of Change, Change By and Comments to Owner (Optional) must be entered to save a Show Info Record. The Show Info Activity Types are Open House, Ad Placement, Broker Open and Scheduled Appointment. Show Info records are only shown to homeowners on the internet if the “Comments to Owner” column is not empty. Deleting a Show Info record will remove the foreign key reference in corresponding tables.

For security, Agents associated with the listing can update Show Info. AM's and Sales Mangers associated with the office in which the listing was taken can update Show Info. System Administrators can update all listings. Users can enter, update and delete View Showing Info. External System Feeds are applicable to showing information as follows. The Show Info information will be accessible to Owners of Listed properties by the proprietor Internet site. Each owner will have a particular code that will show status information about that property. Only Dates, Types and Homeowner comments will be displayed.

X. Schedule Appointments

Scheduling Appointments allows agents to schedule appointments for a current listing. These scheduled appointments are for the proprietor agents and co-brokers. Appointments are scheduled for both the proprietor agents and co-brokers to show the property. Someone working in an administrative capacity typically schedules appointments. Scheduled appointments are linked to a property listings.

The business rules applicable to scheduling appointments are as follows. Appt Date, Appt Time, Agent, Agency and Agent Phone must be entered to save a schedule appointment record. Remarks are optional. The Created By, Created Date, Last Changed By, Last Changed Date are tracked. When Schedule Appt is saved or created, a Showing Info record with the Date, Time and type is made. Agent, Agency, and Phone number info is dumped into the internal comment section. Store the ID of the newly created show info record in the Appt Record. If Scheduled Appointment is deleted, the corresponding Show Info record is removed.

For security, Agents associated with the listing can update appointments. AM's and Sales Mangers associated with the office in which the listing was taken can update appointments. System Administrators can update all listings. Users have several available actions including entering, updating, and deleting appointments. Agents can Show appointments on their properties and the Duty Desk can enter, update and delete appointments across listings.

Y. Outgoing Referrals

The proprietor of the real estate company works with external relocation companies. By sending outgoing referrals to these companies, both agents and the proprietor can earn additional compensation if that referral becomes a buyer through the relocation network. Agents can enter outgoing referrals. The Relocation Department can monitor all outgoing referrals and post commissions.

Business Rules apply to outgoing referrals as follows. A contact can only have one outgoing referral at a time. Agents can only enter outgoing referrals against contacts that they own. The outgoing referral expiration date field is selected from the following: Status; Expired; Lost Opportunity; Assigned; and Denied. No commission adjustments are allowed for void and re-post outgoing referrals. Split levels on the outgoing referral schedule can never be higher than the split levels on the earning schedule. There are manager overrides for outgoing referrals.

For security, Agents can maintain their own outgoing referrals. The relocation department can maintain all outgoing referrals. System Administrators can maintain all outgoing referrals. Users have several available actions based upon their classification as follows. Agents can enter outgoing referrals and view existing outgoing referrals. The Relocation Department can view all outgoing referrals, filter by status, sort by date and access the Commission screen.

Z. Survey

As part of the Customer Care process, the proprietor sends out surveys 602 to their customers. The surveys 602 are produced by a desktop publishing package, but the corresponding multiple-choice answers will be captured by the Listing System for analysis. Preferably, there are a plurality of survey forms. Surveys do not need to be printed from the Listing System. Survey forms may change, so questions and answer options should be data driven. An interface will be provided to capture answers for a contact. The system capture form will have the same questions and responses as the printed forms. There will not be an interface for modifying the questions and answers, this can be accomplished through direct data access.

Business Rules are applicable to surveys as follows. During entry of new marketing programs existing marketing programs will be matched based on program name. The marketing program cannot be deleted once a listing transaction is associated with the marketing program. Listings can only be associated with Active Marketing Programs. Status can be Active or inactive. To create a marketing program, the name must be entered. For security, System Administrators can maintain survey information. Users capture survey information.

VI. Data Creation and Maintenance

The data architecture supports a database server, database connectivity, data model, data maintenance, data conversion, data archiving and auditing capabilities. The database server preferably utilizes Microsoft SQL Server 6.5 as the database engine for the Listing System. Microsoft's Active Data Objects (“ADO”) version 2.0 is used to establish database connectivity between the business objects and the database. An ODBC System DSN must be created on the MTS server. Preferably, the DSN name, username and password are stored in the system registry. The data model for the Listing System is maintained in ERwin 3.5. ERwin 3.5 is used for maintaining the data dictionary, primary and foreign key definitions and triggers. The primary code tables used to store generic codes such as Ad Request Types, Listing Status must be maintained. Referring now to Table 1, the code table structure is shown. In another embodiment, a user interface is provided for maintaining the codes of Table 1. Alternatively, the codes of Table 1 are treated as system code tables and only maintained by system developers. If there are MLS specific codes, the MLS specific codes can be maintained by downloads.

TABLE 1

| | |
|---|---|
| CodeID | System Generated Key |
| Domain | Type of Code, e.g., Ad Request Type, |
| | Listing Status |
| Description | Code Value |
| Abbreviation | Used in reporting or on-screen values |
| DisplayOrder | Order to show values in a list box |
| ValidFlag | Used to de-activate a value |

Data conversions can automatically reformat existing data in external formats such as Microsoft Access and Microsoft Excel for compatibility with the subject system and method. Alternatively, data conversions can require manual re-entry for all current Listing data. In another embodiment, the databases of the subject system and method may be archived onto disks locally, at a central facility or the like as is well known to those skilled in the art and therefore not further described herein. Each of the database will have audit requirements. Preferably, all core data tables will have Date of Entry, Data of Change, Entry User and Last User Change ID's as an audit requirement.

In another embodiment, a client may have a secured area to store personal information. As a result, the client is freed from the burden of maintaining a traditional safety deposit box. The personal information may be a real estate folder containing the paperwork related to the clients real estate purchases and sales. The personal information may even have been scanned in.

It is noted that while the exemplary description herein refers to specific individual databases, formats, records and fields, those skilled in the art will readily appreciate that various modifications and substitutions may be made thereto without departing from the spirit and scope of the present invention.

VII. Batch Processing

In yet another embodiment, batch processing capability enhances efficiency. The system and method provides for automatic daily download of refreshed MLS data. The refreshed data is posted to server 12. The commission process utilizes batch processing as well. For example, a nightly process updates agent splits on pending sale transactions to accurately predict future cash flow for the real estate office. At the end of the fiscal year, the system and method resets the earnings and splits levels of agents that are used for calculating commission splits on sales transactions. It is envisioned that all batch processing and data feeds will have associated control files with record counts and total dollar amounts to ensure auditability.

By way of example, sales agents have a user interface consisting of text and graphics, which allows them to manage their contacts, listings and sales. A forms management interface transfers basic information to a number of forms associated with a sale or listing, including MLS forms. A control mechanism allows sales agents to access a variety of “actions” associated with each listing and sale, such as advertising copy, requests and appointment information. An agent can view listings and monitor activity relating to their listings. For example, an email interface can notify a sign company when the listing agreement is signed and further notifies the listing agent when an appointment is taken for a listing to be shown. Preferably, access to the subject invention is available wherever a user has access to the Internet. For example, a sales agent can be at home, in the office or at a remote location, and access the contact database.

VIII. Reports and Forms

In a preferred embodiment, a multitude of reports and forms are generated. Preferably, the standard reporting tool is Seagate's Crystal Reports v7.0 which enables report templates to be constructed for standard reports. The list of available reports will be data driven, therefore allowing new reports to be entered into the system without requiring a coding change. In one embodiment, the steps to enter a new report into the Listing System are:

1) Use Crystal Reports create a new report which includes the template and the SQL query; and

2) Use Microsoft Access to create a row in the reports table.

In one embodiment, the standard list of reports and forms vary from simple (i.e., report usually consisting of a simple listing) to complex (i.e., reports with multiple sorts, calculated fields and the ability to select one or more ranges). For example, a New Listing Report is a selection of new listings taken during a specified period of time. The New Listing Report can be run for a specific office, region, special division, property transaction type or the entire company with or without a detailed and summary option. The summary option subtotals by office, then by region, then by company. The summary report shows the average listing commission and breaks out the listing versus selling portions of the commission. The New Listing Report adheres to several rules as follows: (i) when selecting by region, the office selection is disabled and when selecting by office the region selection is disabled; (ii) the reporting period selection relates to the original listing date for the listings; (iii) the summaries are only included on the report if the user specifies include summary; and (iv) the listing versus selling portions of the average listing commissions are calculated based on the corresponding values stored in the listing table for each office, region, and the entire company.

For another example, a Listing Expiration Report is selections of listings due to expire within a specified period of time. The Listing Expiration Report can be run for a specific office, region, special division, property transaction type or the entire company with a detailed and summary option. The summary option for the Listing Expiration Report subtotals by office, then by region, then by company. The Listing Expiration Report adheres to several rules as follows: (i) when selecting by region, the office selection is disabled and when selecting by office the region selection is disabled; (ii) the reporting period selection relates to the expiration date for the listings; (iii) the summaries are only included on the report if the user specifies that the summary is to be included; and (iv) the summaries calculate the number of listings which will expire based upon user selected criteria for each region, office, and the entire company.

For still another example, a New Sales Transaction Report details new sales transactions during a specified period of time. The New Sales Transaction Report can be run for a specific office, region, special division, property transaction type or the entire company. The New Sales Transaction Report has a detailed and summary option. The summary option of the New Sales Transaction Report subtotals by office, then by region, then by company. Several calculations are performed when reporting unit, sales volume and company dollar activity based upon the credit given to a particular office for the listing portion versus the selling portion of a sales transaction. The Listing Expiration Report adheres to several rules as follows: (i) when selecting by region, the office selection is disabled and when selecting by office the region selection is disabled; (ii) the reporting period selection relates to the contract date for the sales where new sales transactions will not show up on the report if no contract date has been entered for the sale; and (iii) the summaries are only included on the report if the user specifies to include the summary. The summaries calculate units, volume and company dollar activity for each region, office, and the entire company. Units are the total number of sales for each selling office. Volume is the total contract price of the sales for each selling office and company dollar activity is the volume total for the company.

For still another example, Void Sales Transaction Report details sales transactions which were subsequently voided. The Void Sales Transaction Report can be run for a specified period of time as well as for a specific office, region, special division, property transaction type or the entire company. There is a detailed and summary option available for Void Sales Transaction Reports. The summary option for Void Sales Transaction Reports subtotals by office, then by region, then by company. Several calculations are performed when reporting unit, sales volume and company dollar activity. The Void Sales Transaction Report adheres to several rules as follows: (i) when selecting by region, the office selection is disabled and when selecting by office the region selection is disabled; (ii) the reporting period selection relates to the void date for the sales; and (iii) voided sales transactions will not show up on the report if no void date has been entered for the sale; (iv) the summaries are only included on the report if the user specifies include summary; and (v) the summaries calculate units, volume and company dollar activity for each region, office, and the entire company.

In still another example, Projected Closings Report set forth sales transactions which are due to close on a date in the future. The Projected Closings Report can be run for a specified period of time and for a specific office, region, special division or the entire company with or without a detailed and summary option. The summary option subtotals by office, then by region, then by company. The format of the report follows a monthly trending outline. The Void Sales Transaction Report adheres to several rules as follows: (i) when selecting by region, the office selection is disabled and when selecting by office the region selection is disabled; (ii) the reporting period selection relates to the projected closing date for the sales; (iii) projected closings will not show up on the report if no projected closing date has been entered for the sale; and (iv) the summaries are only included on the report if the user specifies include summary. The summaries calculate units, volume and company dollar activity for each region, office, and the entire company.

In yet still another example, the Closed Sales Transaction Report identifies sales transactions that have a status of closed. The Closed Sales Transaction Report can be run for a specified period of time and for a specific office, region, special division or the entire company with or without a detailed and summary option. The summary option subtotals by office, then by region, then by company. In order to include reporting unit, sales volume and company dollar activity, a few calculations are required. The Closed Sales Transaction Report adheres to several rules as follows: (i) when selecting by region, the office selection is disabled and when selecting by office the region selection is disabled; (ii) the reporting period selection relates to the closed date for the sales; (iii) closed sales transactions will not show up on the report if no closed date has been entered for the sale; and (iv) the summaries are only included on the report if the user specifies include summary. The summaries calculate units, volume and company dollar activity for each region, office, and the entire company.

For another example, a Deposit Verification Report tracks sales transactions which have closed on a specific day or within a specified period of time. The detail and summary formats of the Deposit Verification Report indicate information pertinent to the deposits of moneys received from a closed sales transaction and the commissions due to be paid to the sales agents and others. The Deposit Verification Report includes summaries which can be used to compare against the outputs of an accounting module. Additionally, commission screens can also be printed out with the Deposit Verification Report. The Deposit Verification Report adheres to several rules as follows: (i) the reporting period selection relates to the closed date for the sales; (ii) deposit and commission information will not show up on the Deposit Verification Report if no closed date has been entered for the sale (Preferably, to specify a specific day, a user leaves a “To” field on the entry screen blank and to specify a specific period, wherein a user enters dates in both the “From” and “To” fields on the entry screen); (iii) the summaries are only included on the report if the user specifies include summary; (iv) the summaries calculate units, volume and company dollar activity for each region, office, and the entire company; (v) the commissions screens may be printed from the Deposit Verification Report or alternatively, a user can access the commissions screen and print the information therein from that point; (vi) deposit information comes directly from information entered on a trustee tracking screen; (vii) commissions due to be paid are calculated based on amounts calculated in the commissions screen; (viii) the Deposit Verification Report uses stored procedures to accomplish the calculations required, wherein the deposits and commissions information is also included in separate subreports within the Deposit Verification Report; and (ix) the deposits and conmmissions subreports are linked to the Deposit Verification Report.

For still another example, the Agent Transaction Report identifies agent activity for a specified period of time. The Agent Transaction Report shows agent earnings for closed transactions. Fields on the Agent Transaction Report include date, property address, commission amounts and split at which the agent was paid. The Agent Transaction Report is used to prove agent earnings to date and to facilitate a review of the split at which agents are paid for specific transactions. The Agent Transaction Report adheres to several rules as follows: (i) the reporting period selection relates to the post date for the sales wherein agent transactions will not show up on the report if no post date has been entered for the sale; and (ii) agent earnings information is based on amounts calculated in the commissions screen.

In another example, an Agent Roster Report provides a listing of sales agents in the company. The Agent Roster Report can be run for a specific office, region or the entire company. The summary report of the Agent Roster Report specifies agent count by office indicating the number of agents at the beginning of the report period, the number which joined, the number which terminated and the count at the end of the reporting period. Further, a detail report can be included which conveys information which is captured from personnel records. The Agent Roster Report adheres to several rules as follows: (i) when selecting by region, the office selection is disabled and when selecting by office the region selection is disabled; (ii) the reporting period selection relates to the start date and departure date for the agent; and (iii) the summaries are only included on the report if the user specifies include summary.

In still another example, an Agent Goal Analysis Report provides agent sales activities and compares that activity to goals which are entered at the beginning of a year. In one embodiment, the goals are the number of listings for the agent, the number of sales and target agent earnings for the fiscal year. The Agent Goal Analysis Report shows results for the year including, without limitation, listings taken in units and volume, sale transactions broken out into listing portion and selling portion, showing units, volume and pending agent earnings, closed transactions, agent earnings and company earnings. The Agent Goal Analysis Report adheres to several rules as follows: (i) when selecting by region, the office selection is disabled, wherein region refers to regions assigned to offices to which an agent is assigned and when selecting by office the region selection is disabled wherein office refers to offices to which an agent is assigned; and (ii) the reporting period is based on the current fiscal year, therefore the listings taken information requires that the original listing date be within the current year to be included within the Agent Goal Analysis Report. Sales transactions included in the Agent Goal Analysis Report must have a contract date within the current year. Similarly, closed transactions included within the Agent Goal Analysis Report must have a closed or posted date within the current year. The current year is based upon the system date stored in an internal calendar of the system. Units is the total number of sales belonging to a particular agent. Volume is the amount of money an agent made on a given sale. Volume for listings taken is calculated based on the earnings amount calculated when a sale is posted on the system. Sales transactions include only those which are under contract and closed transactions include only those which are closed or posted. Pending agent earnings for sales transactions will not show up on the report unless commissions have been calculated and saved for that sale and agent earnings for closed transactions are based on amounts calculated when a sale is posted. Company earnings for closed transactions are not broken out by sale versus listing and are calculated in the commissions screen.

For another example, a Contact Report provides basic contact information including entry date, source, name, address, city, state, zip, home phone, work phone, associated agent and the like. The user has the ability to select a type of contact such as seller, buyer, or select all. Preferably, the Contact Report sorts alphabetically, but alternatively allow sorting upon different criteria like selecting contacts for a specific agent.

For another example, a Trustee Account Detail Report summarizes the moneys being held for trustee deposits. The Trustee Account Detail Report shows the balance on deposit for each customer. The Trustee Account Detail Report prints the individual deposits and disbursement information including an ending balance. Further, subtotals for each office allow accounting to reconcile balances to associated bank accounts. The summaries are only included on the report if the user specifies include summary.

For still another example, a Pending Referral Report shows the pending referrals for a particular office. As a result, administrative and sales managers can follow up with sales associates on assignment of referrals and communications with other offices and departments. Preferably, the Pending Referral Report can be selected to run pending referrals to sort in agent order and then by office, wherein a pending referral can have a field associated with it to indicate whether the pending referral is open (i.e., unassigned), assigned to an agent or both.

It is also envisioned that a plurality of forms can also be generated by the subject system and method. In one embodiment, the standard forms tool is a combination of Caere's OmniForm version 3.0, Microsoft's Word 97 and Adobe's Acrobat version 3.0.1. Preferably, form templates are constructed for all forms. The summary data sought will determine the list of available forms. In one embodiment, the following forms are provided: Open Buyer or Tenant Authorization; Exclusive Right to Represent Buyer to Tenant; Dual Agency Consent Agree; Dual Agency/Single Agent Consent; Standard Form Real Estate Contract; Release and Hold Harmless; Exclusive Right to Sell Listing Contract; Exclusive Right to Lease Listing Contract; Exclusive Agency Listing Contract; Sign Request; Exceptional Properties Division Listing Information; State Department of Consumer Protection—Residential Property Condition Disclosure Report; Rider—Real Estate Contract; Addendum to Sales Contract; Order Entry Form; New Listing Input Form; Property Status Change Form; and Disclosure Format for Target Housing Sales—Disclosure of Information on Lead-Based Paint.

IX. Centralized Embodiment for Various Entities

In an alternative embodiment, a central entity creates environment 10 in order to rent capacity to smaller real estate companies. Thus, smaller real estate companies, which would not otherwise be able to afford the benefits offered by the subject invention, can lease the service provided by environment 10 in proportion to usage.

X. Deployment, Operation and Backup

Initial installation of the system software to support the system and method may be via CD ROM or network share. Alternatively, downloading of the system software via modem may occur. Intermediary updates of the components can be done via modem as well. It is envisioned that after installation ongoing management of the system server may be required. Preferably, basic performance monitoring utilizes the built-in tools provided by NT, IIS, and SQL Server.

Accordingly, IIS and ASP can be monitored using the NT Performance Monitor application. Performance monitoring is only activated on an as needed basis as the performance of the system will be impacted somewhat due to the overhead of capturing performance data in the corresponding log. Once captured, the statistics in the log file can be reviewed by proper personnel. In one embodiment, the performance log contains a detailed record of the pages that were accessed on the Web site of the subject system.

In another embodiment, the SQL Server services can also be monitored using the NT Performance Monitor application. Criteria for performance monitoring include available device, log growth, server disk space, physical disk average queue length and current queue length, percentage of processor time and percentage privileged time; cache hit ratio for server 12, cache number of free buffers, I/O Log writes per second, I/O Transactions per second, and page faults per second. A user can also set up alerts for notification when the log has reached a predetermined threshold. If the performance is lacking, several options are available to enhance performance. For example, the Technet Article “MS SQL Server 6.5 I/O Performance Tuning Quick Reference” by Henry Lau and “Internet Information Server 4.0 Tuning Parameters for High-Volume Sites” by Michael Stephenson, which are each incorporated herein by reference, respectively, disclose several techniques to further enhance performance.

The system and method also contemplate backing up or archiving of pertinent data. While it is possible that a multitude of schemes of what data to back up and how often will suffice, the guidelines which follow provide an exemplary scheme. Pertinent Data which is affected by operation of the system should be backed up. The system SQL Server Database contains all of the data maintained and owned by the proprietor of the subject invention and should therefore be backed up frequently. Files which include data referenced with the subject invention such as property picture files should also be archived although less frequently. The financial system database which contains entries based upon certain activity within the subject invention also requires archiving. Data which requires frequent backup can be archived nightly. Additionally, the log files of the system should also be backed up. Thus, recent data will be available. However, if point-in-time recovery is required, that is, the ability to restore the database to a given state up through a specified transaction time, the frequency of the backups should increase. The frequency should correlate to the frequency of data modifications, and how recent the data must be in the event of a failure. For example, if it suffices to restore to the prior days data state, then a full nightly backup would be all that is required. On the other hand, if the data changes frequently, and if it is important to stay as current as possible in the event of a failure, the log files should also be backed up. One strategy would be to back up the log files twice per day. This would allow you to restore the database to its state as it existed at the most twelve hours previously. If a smaller window is required, the log files could be backed up more frequently. When determining backup frequency, the impacts on system performance during these backups must be considered. In addition to archiving, emergency repair disks can be made for server 12. The emergency repair disks can be updated on a regular basis, preferably, any time new software is added to the machine.

In another embodiment, standard operating procedures includes synchronization of the listing system database and financial system database. Under archiving circumstances, a means should be available to determine that, once restorations take place to one or both databases, the two databases are synchronized. Synchronization techniques are well know to those skilled in the art and therefore not further discussed herein.

XI. Exemplary User Interfaces

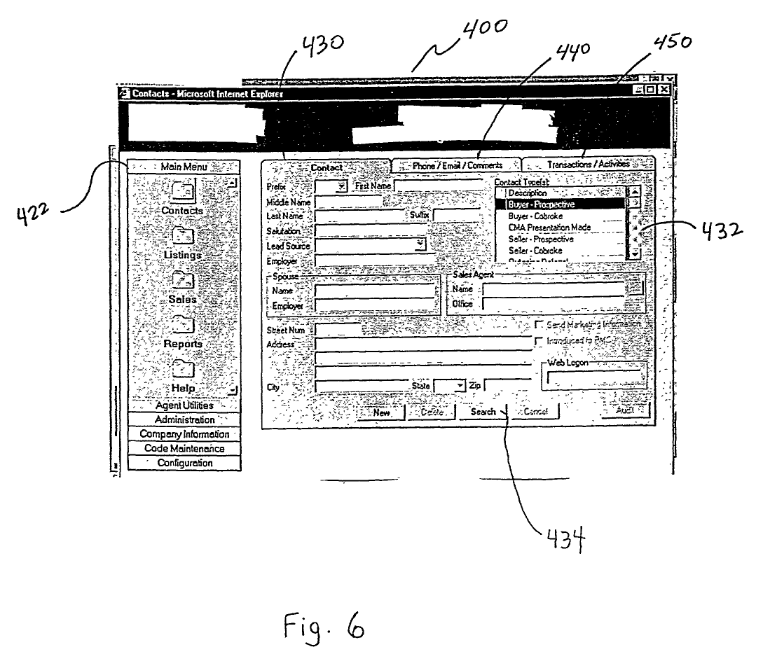

Referring to FIG. 5, an exemplary World Wide Web page (“Web page”) relating to a property in accordance with the present disclosure is illustrated. It should be recognized that “Web page”, “video display” and “screen” will be used interchangeably throughout the specification. Web tier 24 displays the property screen, designated generally by reference numeral 300. Main menu 322 can be selected to provide the user with several options such as contacts, listings, sales, reports, help, agent utilities, administration, company information, code maintenance, configuration and the like. Several tabs are presented which allow a user to select between a property tab 330, a sellers/agents tab 340, a comments tab 350 and a picture/MLS tab 360.

With continuing reference to FIG. 5, the data relating to the property tab 330 is shown. Area 332 includes fields for status and marketing identification number. Area 334 contains fields for describing what type of property is involved, such as whether or not the client is a relocation client. Area 336 provides information regarding the occurrence of certain events. For example, one field within area 336 contains the original list date of the property. Area 338 pertains to the location of the property and area 339 allows for searching according to listing actions.

Referring to FIG. 6, an exemplary World Wide Web page relating to a contact is illustrated. Web tier 24 displays the contact screen, designated generally by reference numeral 400. Main menu 422 can be selected to provide the user with several options such as agent utilities, administration, company information, code maintenance, configuration and the like. Several tabs are presented which allow a user to select between a contact tab 430, a phone tab 440 and a transaction tab 450.

With continuing reference to FIG. 6, the data relating to the contact tab 430 has been selected. Contact tab 430 includes fields for first, middle and last name, salutation, lead source, employer, spouse name and employer, sales agent name and office, address and web logon identifier. Contact tab 430 also includes area 432, which includes a scroll menu, as is common in the art. The scroll menu in area 432 contains data relating to buyers, sellers and the like. To initiate a search for a contact, a user enters data into area 430, such as the last name of the contact in the last name field, and selects the search icon 434 within area 430. During searching, the name fields of the records in the contact database are compared for a match. Once an entered contact name is matched within the data tier, web tier displays to the user the associated contact information.

Although specific examples have been illustrated in FIG. 5 and FIG. 6, it will be appreciated by those skilled in the art that variations or modifications thereto will achieve the desired results necessary to practice the subject invention and as such is considered within the scope of the subject invention.

XII. Process Flowchart

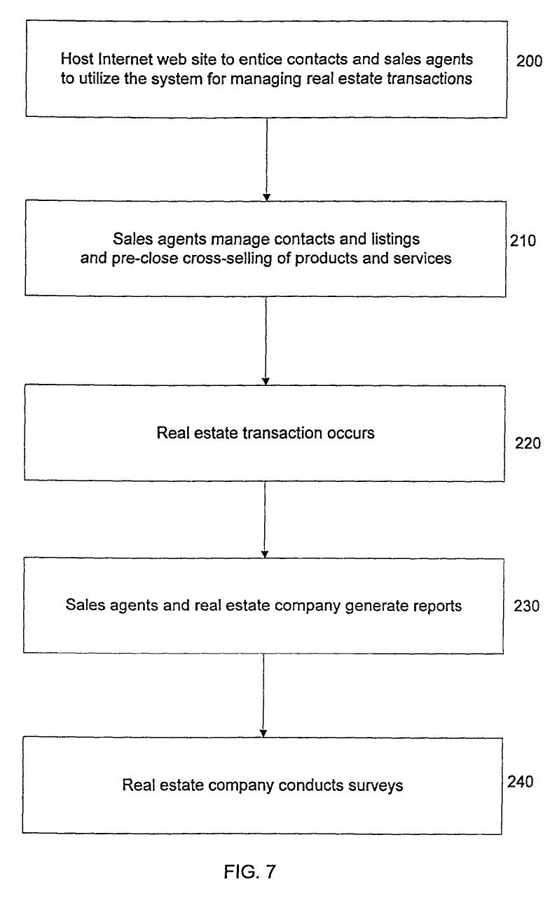

Referring now to FIG. 7, there is illustrated a flowchart depicting a process for managing a real estate company in accordance with an embodiment of the present invention. At step 200, the real estate company hosts a web site and a LAN to provide access to data tier 24. In a preferred embodiment, the real estate company web site provides users access to information such as a real estate company profile, sales agent biographies, school information, neighborhood information and local tax rate information. Further, the real estate company web site may contain banner advertisements and links to related web sites which generate additional revenue streams for the real estate company. Preferably, the banner advertisements and links are associated with national and local vendors of real estate related goods and services.

Additionally, the real estate company web site and LAN allow real estate agents to enter and access data stored in data tier 24. The flexibility of remote access provides convenience for sales agents and, in turn, increased utilization. Preferably, data tier 24 is updated on a daily basis to reflect the current status of contacts and listings. Management of the real estate company utilizes system 10 to evaluate regional office and sales agent performance. A multiplicity of reports, both standard and customized, yield up to date data in a usable format. Further, it is envisioned that the system and method provides for administration and security maintenance, thus security groups are defined. Therefore, although each user of the subject invention has access to system 10, each group's access is controlled. Web tier 20 specifies who can access the different aspects of the system and at what level.

Still referring to step 200, when a contact decides to use the services of the real estate company, the contact signs an agreement with a real estate agent. A contact may be a potential buyer of real estate or an entity desiring to sell a particular piece of real estate. Therefore, the agreement may be a buyer agreement or an agreement that the contact will list their real estate through the real estate company, i.e. a listing agreement. Such agreements commence a first phase in the cycle of a real estate transaction.

Referring to FIG. 7, still at step 200, the data relating to the contact and listing are entered into data tier 24. Administrative personnel assign an MLS number in system 10 once the listing has been entered into a MLS and maintain customized advertising copy for each listing and media source. Preferably, a select list of information fields are automatically updated periodically via a MLS interface. For example, an online MLS may have pictures associated with a listing. If the curb appeal of the house has undergone improvements, a new picture can be uploaded and incorporated. Therefore, data tier 24 provides current information, at all times, without the expense of reprinting.

At step 210, system 10 records all transactions that the contact is involved with and keeps a tally of direct mail sent to contact. It is envisioned that data relating to contacts and listings will also include a history of all real estate related goods and services provided. For example, any disbursement made by the real estate company or a trustee are automatically associated with a sale record. As a result, the need for laborious manual reconciliation of escrow accounts is eliminated. The subject invention provides for continuing communication with contacts by creating a series of different data tables. These tables are accessed and exported for direct mail merges. After the mail merge jobs have been completed and confirmed, the program marks the contact record and sets the flags within the listings database and sales database to indicate completion of the mailing. The subject invention also contemplates mining the data collected to publish a newsletter which is used as a marketing vehicle for the real estate company.

Still referring to step 210, sales agents and real estate company management track contact activity and generate reports on a continuing basis. For example, listing reports, financial reports, real estate agent reports and contact reports quickly and efficiently present data in a format which is easily reviewed and customized. The reports are accurate because web tier 24 is updated on a periodic basis. Thus, real estate companies and agents garner an advantage of accurate reports and assessments over real estate companies who are required to expend large resources to achieve comparable objectives. Furthermore, advertising copy, lock box information, ordering of signs, open house requests, advertising requests and scheduling appointments for showings are all conveniently maintained and accessible within system 10.

At step 220, the real estate cycle enters another phase as a real estate transaction occurs. The buyer and seller reach an agreement and a closing date is determined. For example, a contact may be selling or purchasing a piece of real estate. Thereupon, the status of the listing and contact are updated within data tier 24 and system 10 automatically updates commission data and the like. Therefore, any new reports will reflect all data entered.

At step 230, users access data and generate reports relating to the real estate transaction. Preferably, all the information relating to a contact or a listing can be display on one Web page. An accounting software program properly pays the real estate agent, real estate company and external commissions via a payroll module. Still referring to step 230, management of the real estate company monitors transactions and generates customized reports. Corporate and sales offices can create detailed and summary reports. Different summary reports include, but are not limited to, listing and sale reports, fmancial reports, agent reports and contact reports. System 10 calculates commission dollars that are due to the real estate company, along with insuring that all referrals are properly recorded. For example, financial reports show the commission income to the real estate company and the dollars to be paid to the sales agents and external agencies. Trustee accounting is also facilitated by the system by each deposit or disbursement transaction being associated and made a permanent part of the sale record. Batch processing allows updating the databases on a periodic basis, for example, nightly, to advantageously keep the data current. Thus, a pending sales report accurately predicts future cash flow.

At step 240, the closing is complete and the real estate cycle enters the next phase in which a real estate company conducts a survey to provide important feedback. Management can also generate reports based upon survey results. System 10 allows the real estate company to freely modify and update surveys. In a preferred embodiment customized forms can be created using OMNIFORM® 3.0, MICROSOFT WORD® 97 or ACROBAT® software version 3.0.1 (available from Adobe Systems Incorporated at 1585 Charleston Road, Mountain View, Calif. 94397), as is well known by those skilled in the art.

While the invention has been described with respect to preferred embodiments, those skilled in the art will readily appreciate that various changes and modifications can be made to the invention without departing from the spirit or scope of the invention.

What is claimed is:

1. A method for managing real estate transactions over a distributed computer network comprising the steps of:
(a) storing data relating to a plurality of listings in a computerized database, each listing owned by an office, each office having a plurality of agents associated therewith, each office having a predefined region and at least one manager associated therewith;
(b) monitoring postings of transactions relating to the plurality of listings; and
(c) calculating commissions for the agents, the offices and the at least one manager associated with a transaction in accordance with a set of parameters.

2. A method according to claim 1, further comprising the steps of storing data relating to advertising in the computerized database and calculating commissions for the offices based upon the data relating to the advertising.

3. A method according to claim 1, further comprising the steps of storing data relating to vendors in the computerized database and calculating commissions for the agents and offices based upon the data relating to the vendors.

4. A method according to claim 1, further comprising the step of storing data relating to contacts in a computerized database, the contacts having agents associated therewith, wherein the contacts have listings associated therewith and the data relating to contacts includes a prefix, first name, last name and home phone number.

5. A method according to claim 4, further comprising the steps of preventing deletion of a contact associated with an external business object and allowing only the agent associated with the contact to view and edit the data relating to the contact.

6. A method according to claim 1, further comprising the step of allowing the plurality of agents to initiate open house requests and advertising requests.

7. A method according to claim 1, further comprising the step of storing data relating to agents in the computerized database, the data relating to agents including status, first name, last name and phone numbers, wherein the agents have at least one title associated therewith, the at least one title selected from the group consisting of agent, sales manager and office manager.

8. A method according to claim 1, further comprising the step of maintaining data relating to the predefined regions used to set agent's commission split levels, whereby the agent's commission split levels determine an agent split percentage based on agent earnings, wherein the agent's commission split level has a first level equal to zero and a ceiling split level equal to a prior level's ceiling plus one unless the ceiling split level is the first level.

9. A method according to claim 1, further comprising the step of maintaining data relating to the predefined regions in a computerized database, the data relating to regions including field selected from the group consisting of a created by field, a date of creation field, a last changed by field and a last changed date field.

10. A method according to claim 1, further comprising the step of maintaining data relating to offices in a computerized database, each agent being assigned to only one office, the data relating to offices including a status selected from the group consisting of incomplete, open and closed, wherein the data relating to the offices includes an office identifier, an office name, an office address, a system identifier, an accounting identifier and a region identifier, wherein the data relating to the offices includes a monthly sales goal, an office listing goal, a referral goal and an earnings goal.

11. A method according to claim 1, further comprising the step of maintaining data relating to the listings in the computerized database, the data relating to the listings including an address, a city, a state, a zip code, a seller identifier, a listing agent, a list date, an expiration date, a list price, a total commission and a listing type, wherein the listing type determines which contracts are printed, wherein the contracts are selected from the group consisting of exclusive right to sell, open agency and exclusive agency.

12. A method according to claim 1, wherein the commissions are based upon flat fees and percentages, the percentages being between one percent and fifteen percent and the flat fee being greater than zero and less than a selling price for the listing.

13. A method according to claim 1, wherein the data relating to the plurality of the listings includes a listing status, wherein the listing status is selected from the group consisting of open, under contract, closed and canceled.

14. A method according to claim 1, further comprising storing data relating to sale transactions in a computerized database, the sale transactions consisting of contracts for contacts to purchase listings associated with the real estate company, wherein the data relating to the sale transactions includes an address, a multiple listing system identifier, at least one listing agent, at least one buyer and at least one seller, wherein a maximum of five listing agents and five buyers can be entered in the computerized database.

15. A method according to claim 1, wherein the commissions for the agents are based upon parameters selected from the group consisting of selling price, splits agreed upon between a listing agent and a selling agent, commission splits for agents based upon earning schedules and a marketing adjustment.

16. A method according to claim 1, wherein the commissions for the at least one manager are based upon parameters selected from the group consisting of agent commissions, a predefined period of time and predetermined percentages per office based upon the predefined region and the predefined period of time, wherein when the sale transactions are posted, the commissions for the agent are updated accordingly, wherein when posting the sale transactions, a listing side commission is posted before a selling side commission, the commissions for the agent being recalculated before posting the selling side commission.

17. A method according to claim 1, further comprising the steps of:
(d) tracking trustee money deposited and disbursed from the transactions, wherein each of an action date, a type, a deposit, a disbursement and a received from payee field must be entered into the database to facilitate tracking the trustee money; and
(e) tracking a created by field, a created date field, a last changed by field and a last changed date field for each trustee associated with the trustee money.

18. A method according to claim 1, further comprising the steps of maintaining data relating to attorneys in a computerized database; and
entering a name, a fum, an address and a business phone number for each attorney, wherein the data relating to the attorneys can be edited by the at least one manager and a predetermined administrator.

19. A method according to claim 1, further comprising the step of maintaining data relating to referrals in a computerized database, the referrals being used to calculate the commissions, wherein an agent has initiated multiple referrals for a contact, each of the multiple referrals set to a predetermined percentage according to office guidelines.

20. A method according to claim 1, further comprising the steps of:
(d) maintaining data relating to relocation clients in a computerized database, the relocation clients being external companies that an office partners with for managing corporate relocations, wherein the data relating to relocation clients includes a client identifier, a client name, an address, a phone number, a default percentage and a maximum percentage; and
(e) providing the ability to search for a relocation client.

21. A method according to claim 1, further comprising the step of maintaining data relating to multiple listing services in a computerized database, the data relating to the multiple listing services including a name to allow searching and matching of fields.

22. A method according to claim 1, further comprising the steps of:
(d) maintaining data relating to contact activities in a computerized database, the contact activities including a thank you letter, a survey and a targeted mailing advertisement; and
(e) entering a batch job identifier, a contact identifier, an activity date and a job type identifier for each of the contact activities.

23. A method according to claim 1, further comprising the step of maintaining data relating to lockboxes in a computerized database, the data relating to the lockboxes indicating activity for the lockboxes assigned to one of the plurality of the listings.

24. A method according to claim 23, further comprising the steps of entering as part of the data relating to lockboxes a lock box number, an issued to agent, an issue date, a return date and comments relating to the lockboxes; and
assigning the lockboxes to one of the listings at a time, allowing only a valid agent to sign out a lockbox and requiring a previous lockbox to be marked as returned before a subsequent lockbox can be issued.

25. A method according to claim 1, further comprising the step of maintaining data relating to advertising copy in a computerized database, the advertising copy being used for placing advertisements relating to the listings.

26. A method according to claim 25, further comprising the step of limiting an ad copy record to association with one of the plurality of listings, the ad copy record being part of the data relating to the advertising copy and including ad copy fields selected from the group consisting of a one liner field, a short copy field, a long copy field and a home show field, wherein any of the ad copy fields can be empty.

27. A method according to claim 1, further comprising the steps of:
maintaining data relating to sign vendors in a computerized database, the sign vendors being companies that tend to a sign on a listing, wherein the data relating to the sign vendors is selected from the group consisting of a name, an address, a preferred method of communication, communication data and a vendor identifier;
allowing only the at least one manager to request installation and removal of the signs; and
allowing the at least one manager to approve of advertising requests submitted by the agents, wherein the advertising request must be for a listing associated with an agent who submitted the advertising request.

28. A method according to claim 27, wherein the advertising request is initiated because of an open house request, a link to an open house identifier is associated with the advertising request.

29. A method according to claim 27, further comprising the step of maintaining data relating to advertising placements in a computerized database, the advertising placements being used by the at least one manager to organize the advertising requests for placement in advertising media, where advertising media are selected from the group consisting of television, newspapers, magazines and brochures.

30. A method according to claim 1, further comprising the step of maintaining data relating to showing the plurality of the listings in a computerized database, the data relating to showings is an audit trail of all showings for each of the plurality of the listings and is available over the Internet to a contact who owns a listing, wherein the data relating to the showings is selected from the group consisting of a date, a time, an activity type, a comment by an agent, an entry date, a changed date and a comment by the contact.

31. A method according to claim 1, further comprising the step of scheduling appointments for the plurality of the listings in a computerized database, the appointments being for a listing agent and a cobroker to show a listing, wherein fields entered for appointments are selected from the group consisting of a date, a time, an agent, an agency, an agent phone and a remark.

32. A method according to claim 1, further comprising the step of maintaining data relating to outgoing referrals in a computerized database, the outgoing referrals representing contacts who become buyers and sellers through an external relocation company, wherein the commissions are posted based upon the outgoing referrals yielding transactions.

33. A method according to claim 1, further comprising the steps of:
capturing responses to surveys in a computerized database, the surveys relating to the transaction; and
updating nightly data relating to pending sale transactions in a computerized database in order to accurately predict future cash flows for the office.

34. A system for managing real estate transactions over a distributed computer network comprising:
(a) means for storing data relating to a plurality of listings in a computerized database, each listing owned by an office, each office having a plurality of agents associated therewith, each office having a predefined region and at least one manager associated therewith;
(b) means for monitoring postings of transactions relating to the plurality of listings; and
(c) means for calculating commissions for the agents, the offices and the at least one manager associated with a transaction in accordance with a set of parameters.

35. A system as recited in claim 34, further comprising means for storing data relating to advertising in the computerized database and calculating commissions for the offices based upon the data relating to the advertising.

36. A system as recited in claim 34, further comprising means for storing data relating to vendors in the computerized database and calculating commissions for the agents and offices based upon the data relating to the vendors.

37. A system as recited in claim 34, further comprising means for storing data relating to contacts in a computerized database, the contacts having agents associated therewith, wherein the contacts have listings associated therewith and the data relating to contacts includes a prefix, first name, last name and home phone number.

38. A system as recited in claim 37, further comprising means for preventing deletion of a contact associated with an external business object and means for allowing only the agent associated with the contact to view and edit the data relating to the contact.

39. A system as recited in claim 34, further comprising means for allowing the agents to initiate open house requests and advertising requests.

40. A system as recited in claim 34, further comprising means for storing data relating to agents in the computerized database, the data relating to agents including status, first name, last name and phone numbers, wherein the agents have one title associated therewith, the title selected from the group consisting of agent, sales manager and office manager.

41. A system as recited in claim 34, further comprising means for maintaining data relating to regions used to set agent's commission split levels, whereby the agent's commission split levels determine an agent split percentage based on agent earnings, wherein the agent's commission split level has a first level equal to zero and a ceiling split level equal to a prior level's ceiling plus one unless the ceiling split level is the first level.

42. A system as recited in claim 34, further comprising means for maintaining data relating to regions in a computerized database, the data relating to regions including field selected from the group consisting of a created by field, a date of creation field, a last changed by field and a last changed date field.

43. A system as recited in claim 34, further comprising means for maintaining data relating to offices in a computerized database, each agent being assigned to only one office, the data relating to offices including a status selected from the group consisting of incomplete, open and closed, wherein the data relating to the offices includes an office identifier, an office narne, an office address, a system identifier, an accounting identifier and a region identifier, wherein the data relating to the offices includes a monthly sales goal, an office listing goal, a referral goal and an earnings goal.

44. A system as recited in claim 34, further comprising means for maintaining data relating to the listings in the computerized database, the data relating to the listings including an address, city, state, zip code, seller identifier, listing agent, list date, expiration date, list price, total commission and listing type, wherein the listing type determines which contracts are printed, wherein the contracts are selected from the group consisting of exclusive right to sell, open agency and exclusive agency.

45. A system as recited in claim 34, wherein the commissions are based upon flat fees and percentages, the percentages being between one percent and fifteen percent and the flat fee being greater than zero and less than a selling price for the listing, respectively.

46. A system as recited in claim 34, wherein the data relating to the plurality of the listings includes a listing status, wherein the listing status is selected from the group consisting of open, under contract, closed and canceled.

47. A system as recited in claim 34, further comprising means for storing data relating to sale transactions in a computerized database, the sale transactions consisting of contracts for contacts to purchase listings associated with the real estate company, wherein the data relating to the sale transactions includes an address, a multiple listing system identifier, at least one listing agent, at least one buyer and at least one seller, wherein a maximum of five listing agents and five buyers can be entered in the computerized database.

48. A system as recited in claim 34, wherein the commissions for the agents are based upon parameters selected from the group consisting of selling price, splits agreed upon between a listing agent and a selling agent, commission splits for agents based upon earning schedules and a marketing adjustment.

49. A system as recited in claim 34, wherein the commissions for the at least one manager are based upon parameters selected from the group consisting of agent commissions, a predefined period of time and predetermined percentages per office based upon the predefined region and the predefined period of time, wherein when the sale transactions are posted, the commissions for the agent is updated accordingly, wherein when posting the sale transactions, a listing side commission is posted before a selling side commission, the commissions for the agent being recalculated before posting the selling side commission.

50. A system as recited in claim 34, further comprising:
(d) means for tracking trustee money deposited and disbursed from the transactions, wherein each of an action date, a type, a deposit, a disbursement and a received from payee field must be entered into the database to facilitate tracking the trustee money; and
(e) means for tracking a created by field, a created date field, a last changed by field and a last changed date field for each trustee associated with the trustee money.

51. A system as recited in claim 34, further comprising means for maintaining data relating to attorneys in a computerized database and means for entering a name, a firm, an address and a business phone number for each attorney, wherein the data relating to the attorneys can be edited by the at least one manager and a predetermined administrator.

52. A system as recited in claim 34, further comprising means for maintaining data relating to referrals in a computerized database, the referrals being used to calculate the commissions, wherein an agent has initiated multiple referrals for a contact, each of the multiple referrals set to a predetermined percentage according to office guidelines.

53. A system as recited in claim 34, further comprising:
(d) means for maintaining data relating to relocation clients in a computerized database, the relocation clients being external companies that an office partners with for managing corporate relocations, wherein the data relating to relocation clients includes a client identifier, a client name, an address, a phone number, a default percentage and a maximum percentage; and
(e) means for providing the ability to search for a relocation client.

54. A system as recited in claim 34, further comprising means for maintaining data relating to multiple listing services in a computerized database, the data relating to the multiple listing services including a name to allow searching and matching of fields.

55. A system as recited in claim 34, further comprising:
(d) means for maintaining data relating to contact activities in a computerized database, the contact activities including a thank you letter, a survey and a targeted mailing advertisement; and
(e) means for entering a batch job identifier, a contact identifier, an activity date and a job type identifier for each of the contact activities.

56. A system as recited in claim 34, further comprising:
means for maintaining data relating to lockboxes in a computerized database, the data relating to the lockboxes indicating activity for the lockboxes assigned to one of the plurality of the listings; and
means for entering as part of the data relating to lockboxes a lock box number, an issued to agent, an issue date, a return date and comments relating to the lockboxes.

57. A system as recited in claim 56, further comprising means for assigning the lockboxes to one of the listings at a time, allowing only a valid agent to sign out a lockbox and requiring a previous lockbox to be marked as returned before a subsequent lockbox can be issued.

58. A system as recited in claim 34, further comprising means for maintaining data relating to advertising copy in a computerized database, the advertising copy being used for placing advertisements on the listings.

59. A system as recited in claim 34, further comprising means for limiting an ad copy record to association with one of the listings, the ad copy record being part of the data relating to the advertising copy and including ad copy fields selected from the group consisting of a one liner field, a short copy field, a long copy field and a home show field, wherein any of the ad copy fields can be empty.

60. A system as recited in claim 34, further comprising:
means for maintaining data relating to sign vendors in a computerized database, the data relating to the sign vendors being companies that tend to a sign on each of the plurality of the listings, wherein the data relating to the sign vendors is selected from the group consisting of a name, an address, a preferred method of communication, communication data and a vendor identifier and
means for allowing only the at least one manager to request installation and removal of the signs.

61. A system as recited in claim 34, further comprising means for allowing the at least one manager to approve of advertising requests submitted by the agents, wherein the advertising request must be for a listing associated with an agent who submitted the advertising request.

62. A system as recited in claim 61, wherein the advertising request is initiated because of an open house request, a link to an open house identifier is associated with the advertising request.

63. A system as recited in claim 61, further comprising means for maintaining data relating to advertising placements in a computerized database, the advertising placements being used by the at least one manager to organize the advertising requests for placement in advertising media, where advertising media are selected from the group consisting of television, newspapers, magazines and brochures.

64. A system as recited in claim 34, further comprising means for maintaining data relating to showing the plurality of the listings in a computerized database, the data relating to showings is an audit trail of all showings for each of the plurality of the listings and is available over the Internet to a contact who owns a listing, wherein the data relating to the showings is selected from the group consisting of a date, a time, an activity type, a comment by an agent, an entry date, a changed date and a comment by the contact.

65. A system as recited in claim 34, further comprising means for scheduling appointments for the plurality of the listings in a computerized database, the appointments being for a listing agent and a cobroker to show a listing, wherein fields entered for appointments are selected from the group consisting of a date, a time, an agent, an agency, an agent phone and a remark.

66. A system as recited in claim 34, further comprising means for maintaining data relating to outgoing referrals in a computerized database, the outgoing referrals representing contacts who become buyers and sellers through an external relocation company, wherein the commissions are posted based upon the outgoing referrals yielding transactions.

67. A system as recited in claim 34, further comprising:
means for capturing responses to surveys in a computerized database, the surveys relating to the transaction; and
means for updating nightly data relating to pending sale transactions in a computerized database in order to accurately predict future cash flows for the office.

68. A distributed computer network for managing real estate transactions comprising:
a memory containing:
a data tier program having functions for supporting a database for storing data relating to a plurality of contacts;
a web tier program having functions for managing requests for said data relating to the plurality of contacts and providing said data relating to the plurality of contacts to a plurality of agents;
a client tier program having functions for providing remote access to the database by said plurality of contacts and said plurality of agents;
a business tier program having functions for retrieving and storing said data relating to a plurality of contacts and applying business rules to said data relating to a plurality of contacts in order to generate a report; and
a processor for implementing the web tier program, the client tier program, the business tier program and the data tier program in order to manage real estate transactions.

69. A computer-readable medium whose contents cause a distributed computer system to perform a remote procedure, the distributed computer system having a client program and a server program with functions for invocation, by performing the steps of:
(a) storing data relating to a plurality of listings in a computerized database, each listing owned by an office, each office having a plurality of agents associated therewith, each office having a predefined region and at least one manager associated therewith;
(b) monitoring postings of transactions relating to the plurality of listings; and
(c) calculating commissions for the agents, the offices and the at least one manager associated with a transaction in accordance with a set of parameters.
